(19) United States
(12) Patent Application Publication
(10) Pub. No.: US 2026/0189787 A1
(43) Pub. Date: Jul. 2, 2026

(54) DISPLAY CONTROL DEVICE, DISPLAY CONTROL METHOD, PROGRAM, AND IMAGING DEVICE

(71) Applicant: FUJIFILM Corporation, Tokyo (JP)

(72) Inventors: Hinako SUZUKI, Saitama (JP); Hikaru TOMITA, Saitama (JP); Atsushi MATSUSHIMA, Saitama (JP); Taku YAMASHITA, Saitama (JP)

(73) Assignee: FUJIFILM Corporation, Tokyo (JP)

(21) Appl. No.: 19/547,626

(22) Filed: Feb. 23, 2026

Related U.S. Application Data
(63) Continuation of application No. PCT/JP2024/026110, filed on Jul. 22, 2024.

(30) Foreign Application Priority Data
Aug. 24, 2023 (JP) 2023-136621

(51) Int. Cl. H04N 23/67; H04N 23/63

(52) U.S. Cl. CPC H04N 23/672; H04N 23/632; H04N 23/671; H04N 23/675

(57) ABSTRACT

Provided are a display control device, a display control method, a program, and an imaging device that can achieve image display that brings a visual effect enabling detailed observation of an in-focus region in an image while also allowing recognition of a subject in an out-of-focus region. A display control device includes a processor that acquires an image, acquires information on a focus position of a depth of field of the image, and determines gradation characteristics for displaying the image in accordance with the depth of field and a distance in a depth direction from the focus position in the image.

### CROSS-REFERENCE TO RELATED APPLICATIONS

The present application is a Continuation of PCT International Application No. PCT/JP2024/026110 filed on Jul. 22, 2024 claiming priority under 35 U.S.C § 119 (a) to Japanese Patent Application No. 2023-136621 filed on Aug. 24, 2023. Each of the above applications is hereby expressly incorporated by reference, in its entirety, into the present application.

### BACKGROUND OF THE INVENTION

### 1. Field of the Invention

The present disclosure relates to a display control device, a display control method, a program, and an imaging device, and particularly to an image display technique for clearly displaying an in-focus image region.

### 2. Description of the Related Art

JP6494587B discloses an image processing device comprising: a recording unit that acquires a plurality of image data and records the plurality of image data on a recording medium; an acquisition unit that acquires depth distribution information of a subject corresponding to the image data; and a control unit that performs a recording process of the plurality of image data by switching between a first mode in which the image data and the depth distribution information corresponding to the image data are recorded on the recording medium by the recording unit and a second mode in which the image data is recorded on the recording medium by the recording unit without recording the depth distribution information, in which the control unit acquires the depth distribution information including depth information of a main subject and a background of a plurality of subjects, and controls switching between the first mode and the second mode for the recording process, in accordance with a difference between the depth information of the main subject and the depth information of the background included in the depth distribution information.

JP5300133B discloses an image display device comprising: a subject distance detection unit that detects a subject distance of each subject imaged by an imaging unit; an output image generation unit that generates, as an output image, an image in which a subject located within a specific distance range is in focus from an input image obtained by the imaging via the imaging unit; and a display control unit that extracts an image region in which the subject located within the specific distance range appears in the output image as a focus region based on a detection result of the subject distance detection unit, and displays a display image based on the output image on a display unit such that the focus region is visible, in which the subject distance detection unit detects the subject distance of the subject at each position on the input image based on image data of the input image and characteristics of an optical system of the imaging unit, and the output image generation unit generates the output image by performing image processing on the input image in accordance with the subject distance detected by the subject distance detection unit, the designated specific distance range, and the characteristics of the optical system of the imaging unit in response to the designation of the specific distance range.

### SUMMARY OF THE INVENTION

One embodiment according to the technology of the present disclosure provides a display control device, a display control method, a program, and an imaging device that can clearly present an in-focus region in an image.

A first aspect of the present disclosure relates to a display control device comprising: a processor that acquires an image, acquires information on a focus position of a depth of field of the image, and determines gradation characteristics for displaying the image in accordance with the depth of field and a distance in a depth direction from the focus position in the image.

A second aspect relates to the display control device according to the first aspect, in which the processor may determine the depth of field based on information on an F number of the image.

A third aspect relates to the display control device according to the first or second aspect, in which the processor may determine the gradation characteristics of a region outside a range of the depth of field, and display the image.

A fourth aspect relates to the display control device according to any one of the first to third aspects, in which the processor may acquire a region of a main subject in the image, and make the gradation characteristics different between a first region that is the region of the main subject within a range of the depth of field in the image and a second region that is a region outside the range of the depth of field.

A fifth aspect relates to the display control device according to any one of the first to fourth aspects, in which the processor may acquire distance information for each subject, calculate the distance based on the distance information for each subject, calculate the gradation characteristics based on the distance, and determine the gradation characteristics in accordance with a subject distance of the focus position and the distance.

A sixth aspect relates to the display control device according to the fifth aspect, in which the processor may determine the gradation characteristics based on a value obtained by normalizing the distance by the depth of field of the image.

A seventh aspect relates to the display control device according to any one of the first to sixth aspects, in which the processor may change a gradation of a pixel of a region that determines the gradation characteristics in the image in accordance with information on an F number of the image.

An eighth aspect relates to the display control device according to any one of the first to seventh aspects, in which the processor may determine display brightness of a region outside a range of the depth of field in accordance with a representative value of a region within the range of the depth of field.

A ninth aspect relates to the display control device according to any one of the first to seventh aspects, in which the processor may acquire a region of a main subject in the image, and determine, based on an index value related to brightness of the region of the main subject within a range of the depth of field, the gradation characteristics in a region outside the range of the depth of field.

A tenth aspect relates to the display control device according to the ninth aspect, in which the processor may determine the gradation characteristics for reducing display brightness of the region outside the range of the depth of field in a case where the index value indicates the brightness that is equal to or greater than a first threshold value, and determine the gradation characteristics for increasing the display brightness of the region outside the range of the depth of field in a case where the index value indicates the brightness that is less than the first threshold value.

An eleventh aspect relates to the display control device according to any one of the first to tenth aspects, in which, in a case where an area ratio of a region within a range of the depth of field in the image is equal to or greater than a second threshold value, the processor may change the gradation characteristics for displaying the region within the range of the depth of field, and fix the gradation characteristics for displaying a region outside the range of the depth of field.

A twelfth aspect relates to the display control device according to any one of the first to eleventh aspects, in which the gradation characteristics may be expressed using a gamma function, and the processor may change the gradation characteristics by determining a coefficient of the gamma function.

A thirteenth aspect relates to the display control device according to any one of the first to twelfth aspects, in which the image may be an image captured by an imaging element including a phase difference pixel, and the processor may change the gradation characteristics in accordance with a value of a subject distance acquired from information on the phase difference pixel.

A fourteenth aspect relates to the display control device according to the thirteenth aspect, in which the processor may calculate the value of the subject distance corresponding to a pixel in the image by using a trained model that has been trained in advance on a relationship between the information on the phase difference pixel and the value of the subject distance.

A fifteenth aspect relates to the display control device according to the thirteenth or fourteenth aspect, in which the processor may change the gradation characteristics based on a plurality of combinations of the information on the phase difference pixel and the value of the subject distance.

A sixteenth aspect of the present disclosure relates to a display control method executed by a processor, the display control method comprising: acquiring an image; acquiring information on a focus position of a depth of field of the image; and determining gradation characteristics for displaying the image in accordance with the depth of field and a distance in a depth direction from the focus position in the image.

The display control method according to the sixteenth aspect may have the same specific aspect as the display control device according to any one of the second to fifteenth aspects.

A seventeenth aspect of the present disclosure relates to a program causing a computer to implement: a function of acquiring an image; a function of acquiring information on a focus position of a depth of field of the image; and a function of determining gradation characteristics for displaying the image in accordance with the depth of field and a distance in a depth direction from the focus position in the image.

The program according to the seventeenth aspect may have the same specific aspect as the display control device according to any one of the second to fifteenth aspects. The present disclosure also includes a tangible, non-transitory, computer-readable recording medium, such as a compact disc read-only memory (CD-ROM), on which a program according to the seventeenth aspect is recorded.

An eighteenth aspect of the present disclosure relates to an imaging device comprising: an imaging optical system; an imaging element that captures an image of a subject via the imaging optical system; a display device that displays the image captured by the imaging element; and a processor that controls display of the image on the display device, in which the processor acquires the image captured by the imaging element, acquires information on a focus position of a depth of field of the image, and determines gradation characteristics for displaying the image in accordance with the depth of field and a distance in a depth direction from the focus position in the image.

The imaging device according to the eighteenth aspect may have the same specific aspect as the display control device according to any one of the second to fifteenth aspects.

A nineteenth aspect relates to the imaging device according to the eighteenth aspect, in which the processor may specify the depth of field based on information on an F number of the imaging optical system.

A twentieth aspect relates to the imaging device according to the eighteenth or nineteenth aspect, in which the imaging element may include a phase difference pixel.

### BRIEF DESCRIPTION OF THE DRAWINGS

FIG. 1 is a block diagram schematically illustrating a configuration of an imaging system including a display control device according to an embodiment of the present disclosure.

FIG. 2 is a flowchart illustrating an example of a display control method executed by a processor.

FIG. 3 is a diagram illustrating an example of a display image generated by the display control method according to the present embodiment.

FIG. 4 is a diagram illustrating a relationship between a depth of field and display brightness.

FIG. 5 is a diagram illustrating a method of calculating the depth of field.

FIG. 6 is a graph illustrating an example of input/output characteristics of gamma correction.

FIG. 7 is a graph illustrating an example of a function in a case where a gradation characteristic value in display is determined in accordance with a depth of a pixel.

FIG. 8 is a graph illustrating an example of a function for determining a gradation characteristic value in a case where a set gradation characteristic value a satisfies a <1.

FIG. 9 is a graph illustrating an example of a gradation characteristic value applied in a case where an F number is F2.8.

FIG. 10 is a graph illustrating an example of a gradation characteristic value applied in a case where the F number is F22.

FIG. 11 is a diagram illustrating a configuration example of an imaging element.

FIG. 12 is an enlarged view of a main part illustrating a configuration example of a phase difference pixel.

FIG. 13 is an example of a display image generated in a case where brightness of a region within a range of a depth of field in the image is greater than a first threshold value.

FIG. 14 is an example of a display image generated in a case where the brightness of the region within the range of the depth of field in the image is less than the first threshold value.

FIG. 15 is a diagram illustrating an example of an image brightness setting screen for setting display brightness of a region outside the range of the depth of field.

FIG. 16 is a block diagram illustrating a functional configuration of the display control device.

FIG. 17 is a flowchart illustrating an example of a process of changing brightness of an image in live view display.

FIG. 18 is a graph illustrating an example of a function for determining a gradation characteristic value in a case where an area ratio of the region within the range of the depth of field in the image is equal to or greater than a second threshold value.

FIG. 19 is a diagram illustrating an example of an image captured by using the imaging element including the phase difference pixel and an example of a phase difference image obtained from the phase difference pixel.

FIG. 20 is a diagram schematically illustrating the operation principle of an image plane phase difference autofocus (AF) using the phase difference pixel.

FIG. 21 is a diagram illustrating an outline of a phase difference pixel artificial intelligence (AI) used for a process of estimating the depth of the pixel from the phase difference image.

FIG. 22 is a diagram illustrating an example of depth interpolation calculation.

FIG. 23 is a perspective view of a camera comprising the display control device according to the present embodiment as viewed obliquely from the front.

FIG. 24 is a rear view of the camera illustrated in FIG. 23.

FIG. 25 is a block diagram illustrating an example of an internal configuration of the camera.

### DESCRIPTION OF THE PREFERRED EMBODIMENTS

Hereinafter, a preferred embodiment of the present invention will be described in detail with reference to the accompanying drawings.

### [Outline of Display Control Device]

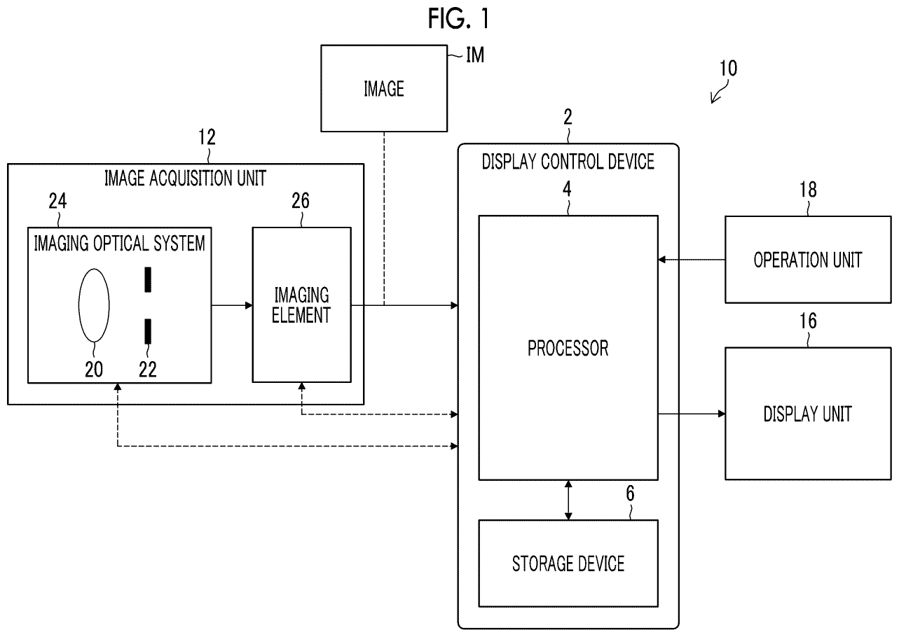

FIG. 1 is a block diagram schematically illustrating a configuration of an imaging system 10 including a display control device 2 according to the embodiment of the present disclosure. The display control device 2 includes a processor 4 and a storage device 6. The imaging system 10 includes an image acquisition unit 12, the display control device 2, a display unit 16, and an operation unit 18.

The processor 4 includes a central processing unit (CPU). The processor 4 may include a graphics processing unit (GPU). The processor 4 may include a digital signal processor and/or a programmable logic device. The storage device 6 is a tangible, non-transitory, computer-readable medium, and is configured by, for example, a semiconductor memory, a hard disk drive device, a solid state drive device, or a combination of a plurality of these devices. The storage device 6 may have a configuration including, for example, a memory as a main memory and a storage as an auxiliary memory. The processor 4 functions as a processing unit that performs various processes by executing a command stored in the memory.

The image acquisition unit 12 acquires an image IM captured in a wavelength range including a visible light range. The visible light range refers to a wavelength range of electromagnetic waves from 360 nm to 800 nm. The image acquisition unit 12 may include a camera that captures visible light. The camera as an imaging device typically includes an imaging optical system 24 including one or more lenses 20 and a stop 22, and an imaging element 26 that captures an optical image formed by the imaging optical system 24 and converts the optical image into an electric signal. The lens 20 may be a zoom lens or a fixed focal length lens. The lens 20 may be an interchangeable lens that is attachable to and detachable from a camera body.

The imaging element 26 is configured by, for example, a complementary metal-oxide-semiconductor (CMOS) type color image sensor. In addition, the imaging element 26 is not limited to the CMOS type, and may be an XY address type or a charge coupled device (CCD) type image sensor. The imaging element 26 need only be configured to detect light in the visible light range, and may have sensitivity in a part of a near-infrared wavelength range. The camera may include an image processing circuit that processes the electric signal obtained from the imaging element 26 to digitize the electric signal.

The imaging system 10 may have an integrated configuration typified by a digital camera, or may have a separate configuration in which an information processing device that functions as the display control device 2 and the camera are connected by wire or wirelessly.

The display unit 16 is configured by, for example, a liquid crystal display, an organic electro-luminescence (OEL) display, a projector, or an appropriate combination of these display devices. The display unit 16 may be, for example, a monitor disposed on a rear surface of the camera body, an electronic view finder, or a combination of these. Further, the display unit 16 may be a monitor of a personal computer, a touch panel display of a portable terminal such as a smartphone or a tablet terminal, or the like.

The operation unit 18 is a user interface for a user to input various instructions and information, and is configured by, for example, various input devices such as an operation button, a dial, a switch, a lever, a joystick, a touch panel, a keyboard, a mouse, other pointing devices, or a voice input device, or an appropriate combination of these. In addition, the display unit 16 and the operation unit 18 may be integrally configured as in the touch panel display.

The image IM acquired via the image acquisition unit 12 may be a still image or a video. For example, the video is captured by the image acquisition unit 12 at a certain frame rate, and a live view image is displayed on the display unit 16. The processor 4 receives an instruction to record the still image or the video from the operation unit 18 while the live view image is being displayed, and executes a recording process of the image in accordance with the received recording instruction. The “recording process” referred to here includes storing a file of the still image or the video in the storage device 6 or the like. For example, in a case where a shutter button is pressed and the instruction to record the still image is input, the processor 4 performs a process of storing the file of the still image. The file format may be, for example, a compressed file format such as joint photographic experts group (JPEG) or high efficiency image file format (HEIF), or a RAW data format, or one image may be stored in a plurality of file formats.

In addition, for example, in a case where a video capturing button is pressed and the instruction to record the video is input, the processor 4 starts recording of the video, and in a case where the video capturing button is pressed again and an instruction to end the video recording is input, the processor 4 ends the recording of the video and performs a process of storing the file of the video in the storage device 6 or the like. As the file format of the video, various formats typified by, for example, MPEG4 (.mp4) or MOV (.mov) can be used.

The video capturing button may be provided separately from the shutter button or used in common with the shutter button. The “button” in the operation unit 18 may be a physical button switch (solid user interface) that operates mechanically, or a graphical user interface that operates like a push button.

### [Outline of Display Control Method]

In a case where the image is captured using a video device such as a digital camera, the screen is small on an electronic view finder or a liquid crystal monitor, and it is difficult to check in detail where the focus is. In order to solve such a problem, for example, a method of visually presenting whether or not focusing is possible by displaying a region other than an in-focus region in the image in black is also possible. However, in such a method, an actual pattern (image content) of an out-of-focus region cannot be seen, which hinders checking of a composition or the like.

The display control device 2 according to the present embodiment provides image display that brings a visual effect enabling detailed observation of the in-focus region in the image while also allowing recognition of the subject in the out-of-focus region.

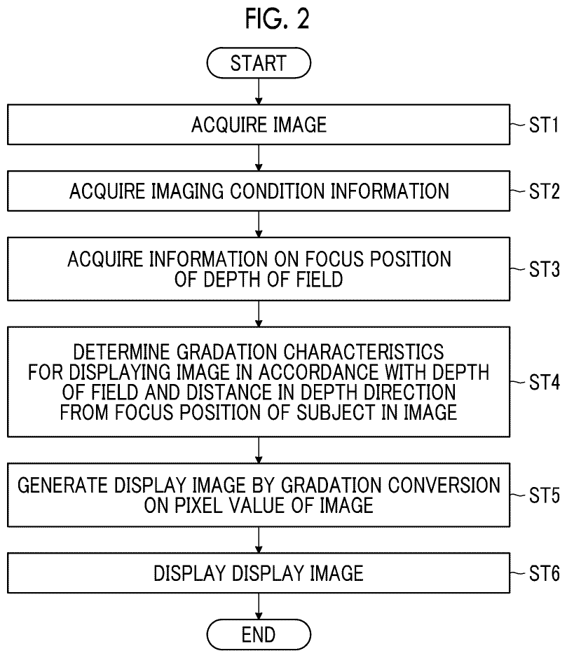

FIG. 2 is a flowchart illustrating an example of a display control method executed by the processor 4.

In step ST1, the processor 4 acquires the image IM that is the processing target.

In step ST2, the processor 4 acquires imaging condition information including a focal length and the F number. The F number is synonymous with an F-number. The imaging condition information is information on imaging conditions in a case where the image IM is captured. The imaging condition information may include positional information of the lens 20. The processor 4 may acquire a part or all of the imaging condition information from the camera side, or acquire the imaging condition information from information stored in the storage device 6.

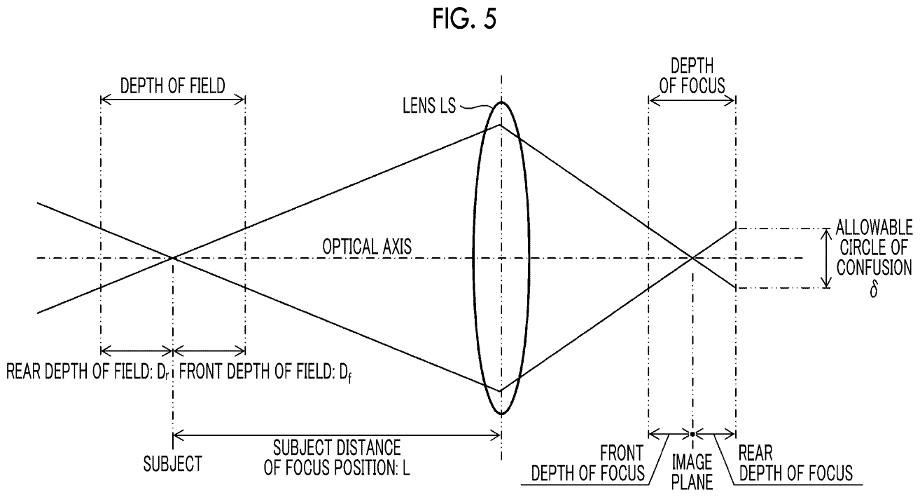

In step ST3, the processor 4 acquires information on a focus position of the depth of field for the image IM. The “focus position” refers to a position at which the subject is perfectly in focus. The processor 4 can calculate a distance from the focus position to the subject and the depth of field by using the imaging condition information (see FIG. 5).

In step ST4, the processor 4 determines gradation characteristics for displaying the image in accordance with the depth of field and the distance in the depth direction from the focus position of the subject in the image. The depth direction is a direction of a depth of the image. The distance in the depth direction from the focus position is a relative distance in the depth direction with the focus position as a reference. Since each pixel constituting the image captures an image of any subject present in the imaging range, the processor 4 can evaluate the distance in the depth direction from the focus position for each pixel by using the depth information of the subject region corresponding to each pixel in units of pixels. The processor 4 can determine the gradation characteristics for displaying the image in units of pixels.

The gradation characteristics can be expressed using, for example, a density conversion function applied to a density conversion process (density gradation conversion process) of a pixel value. The density conversion function may be a table that defines a correspondence relationship between an input pixel value and an output pixel value. The gradation characteristics are expressed using, for example, a gamma function, and the processor 4 changes the gradation characteristics by determining a coefficient of the gamma function. The density conversion process using such a gamma function is called gamma correction, and input/output characteristics can be changed by changing a gamma value that is the coefficient of the gamma function. The determination of the gamma value corresponds to the determination of the gradation characteristics.

For example, the processor 4 determines different gradation characteristics between the region within the range of the depth of field in the image and the region outside the range of the depth of field, makes the display brightness different between the region within the range of the depth of field and the region outside the range of the depth of field, and relatively increases the visibility of the region within the range of the depth of field in the image. The processor 4 achieves a distribution of the changes of the display brightness in accordance with the depth distribution by applying the same gradation characteristics to the pixels of the region within the range of the depth of field, and applying the gradation characteristics determined in accordance with the distance in the depth direction from the focus position for each pixel to the pixels of the region outside the range of the depth of field.

The display brightness refers to “brightness” in display. The display brightness may be referred to as display density. The “brightness” or the “density” of the image can be expressed using a value (pixel value) of a pixel constituting the image. For example, in a case where the image that is the processing target is a digital image of each color of red (R), green (G), and blue (B) in 8 bits, the pixel value of each color of RGB can take a value of 0 to 255. The pixel value 0 expresses the darkest value, and the pixel value 255 expresses the brightest value. The processor 4 can change the display brightness of the image IM by converting the pixel value by applying the gradation characteristics determined based on the depth information of the pixel included in the image IM.

In step ST5, the processor 4 performs density conversion of the pixel value of the image IM by applying the gradation characteristics determined in step ST4 to generate the display image. For example, the processor 4 applies the gradation characteristics having the gamma value of 1 to the pixels of the region within the range of the depth of field in the image IM, and performs density conversion such that the pixels of the region outside the range of the depth of field are brighter or darker as the distance in the depth direction from the focus position of each pixel is larger. As a result, the display image is generated in which a density difference (brightness difference) in display is present between the region within the range of the depth of field and the region outside the range of the depth of field, and the density difference in display in accordance with the distance in the depth direction from the focus position is present in the region outside the range of the depth of field.

In step ST6, the processor 4 displays the display image generated in step ST5 on the display unit 16. After step ST6, the processor 4 ends the flowchart illustrated in FIG. 2. The processes of steps ST1 to ST6 may be repeatedly executed on the image IM acquired in time series.

For example, in a case where live view display of displaying the video being captured on the display unit 16 is performed, the flowchart illustrated in FIG. 2 may be executed for each frame of the video.

### Example of Display Image

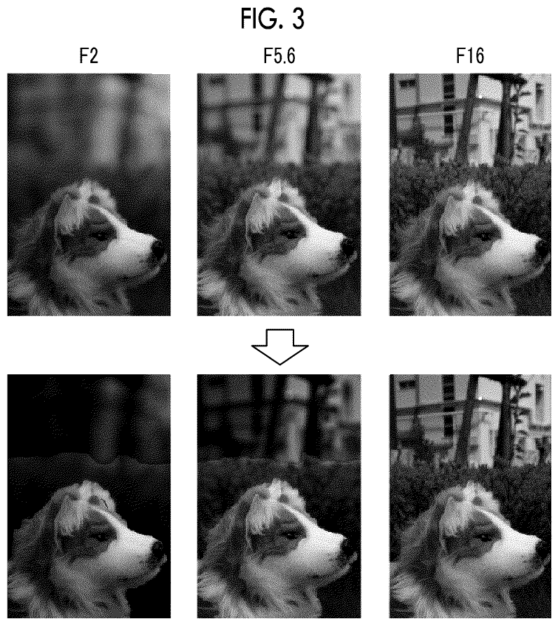

FIG. 3 is a diagram illustrating an example of the display image generated by the display control method according to the present embodiment. An upper part illustrated in FIG. 3 illustrates an example of the display image obtained by applying conventional standard image processing and display control. A lower part illustrated in FIG. 3 illustrates an example of the display image obtained by applying the display control method according to the embodiment. FIG. 3 illustrates an example of the image in each case where the F number is F2, F5.6, and F16. The depth of field changes depending on the F number. As illustrated in FIG. 3, the pixel value of the region within the range of the depth of field is not changed, and the pixel value of the region outside the range of the depth of field is subjected to density conversion to change the display brightness.

### [Relationship Between Depth of Field and Display Brightness]

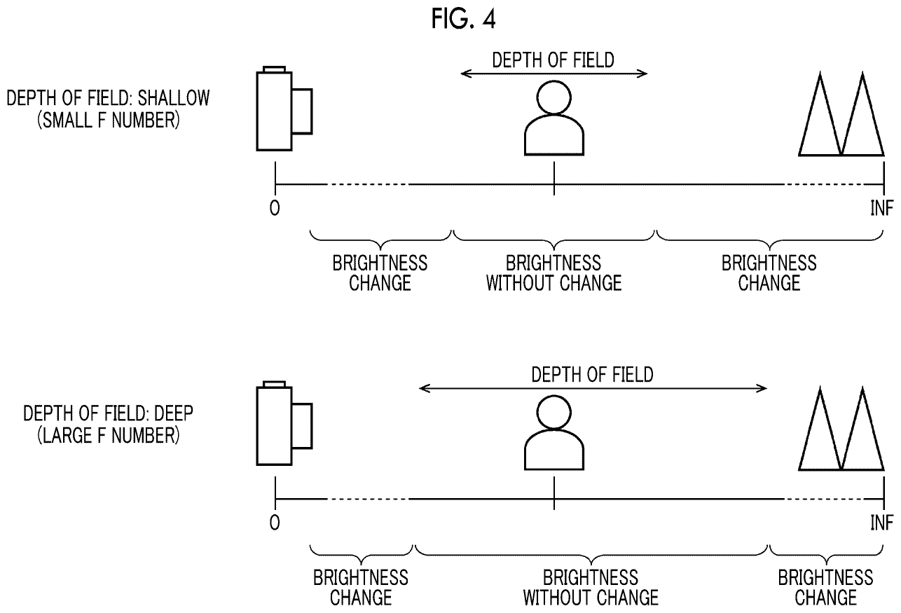

FIG. 4 is a diagram illustrating a relationship between the depth of field and the display brightness. The depth of field depends on the F number (F-number), and the depth of field is shallower as the F number is smaller, and the depth of field is deeper as the F number is greater. That is, the range of the depth of field is smaller as the F number is smaller, and the range of the depth of field is larger as the F number is greater.

In the example of the display control method according to the present embodiment, the display brightness of the pixel that captures the subject present within the range of the depth of field is not changed, and the display brightness of the pixel that captures the subject present outside the range of the depth of field is changed in accordance with the distance in the depth direction from the focus position.

FIG. 5 is a diagram illustrating a method of calculating the depth of field. As illustrated in FIG. 5, using a focal length f of a lens LS, an F number (F-number) F, a distance L from the lens LS to the subject at the focus position, and an allowable circle of confusion δ, a front depth of field D_{f} and a rear depth of field Dᵣ are calculated from Expression (1) and Expression (2). In addition, the distance L is referred to as a “subject distance of the focus position”.

$${D}_{f} = δ \cdot F \cdot {L}^{2} / ( {f}^{2} + δ \cdot F \cdot L ) \qquad Expression ( 1 )$$

$${D}_{r} = δ \cdot F \cdot {L}^{2} / ( {f}^{2} - δ \cdot F \cdot L ) \qquad Expression ( 2 )$$

The range of the depth of field is a range of (rear depth of field Dᵣ+front depth of field D_{f}).

For example, the processor 4 does not change the display brightness of the pixel in which the value of x indicating the subject distance is present in a range of (L−D_{f})≤x≤(L+Dᵣ), and changes the display brightness of the pixel in which the value of x is present in a range of x<(L−D_{f}) or (L+Dᵣ)<x.

### [Density Conversion Process of Image]

The display brightness is changed, for example, by changing the gamma value of the gamma correction.

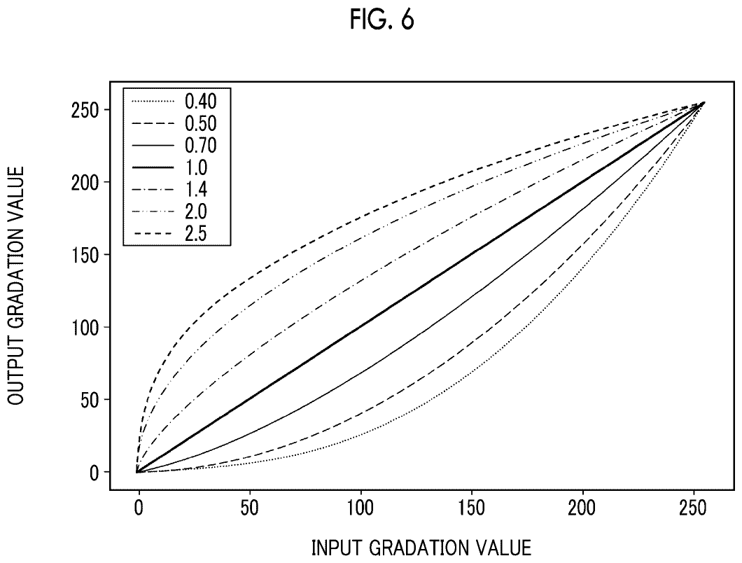

FIG. 6 is a graph illustrating an example of input/output characteristics of the gamma correction. A horizontal axis expresses an input gradation value, and a vertical axis expresses an output gradation value. The gamma correction of an image of 256 gradations expressed using a value of 0 to 255 is performed by Expression (3) to convert a gradation value X before correction into a gradation value Y after correction.

$$Y = 255 \times {( X / 255 )}^{1 / γ} \qquad Expression ( 3 )$$

In a case where γ>1, the overall image is bright, and in a case where γ<1, the overall image is dark.

By applying the gamma correction to each of RGB signal values of the image IM, the pixel value is converted, and the display image is generated. The pixel value may be understood as a density value of the pixel.

In the present embodiment, the display image is generated by applying different gamma values between the region within the range of the depth of field and the region outside the range of the depth of field in the image IM, and changing the gamma value in accordance with the distance in the depth direction from the focus position based on the depth information of the pixel for the region outside the range of the depth of field.

In this way, by displaying the display image in which the density difference (brightness difference) is given in accordance with the distribution of the focus in the image IM on the display unit 16, the visibility of the region in which the focus is in the image IM can be relatively increased, the region outside the range of the depth of field can be visually recognized, and the composition or the like can be checked. The gamma value is an example of a numerical value (gradation characteristic value) expressing the gradation characteristics, and is an example of a “coefficient of the gamma function” according to the present disclosure.

### Example of Determination of Display Brightness in Accordance with Depth of Pixel

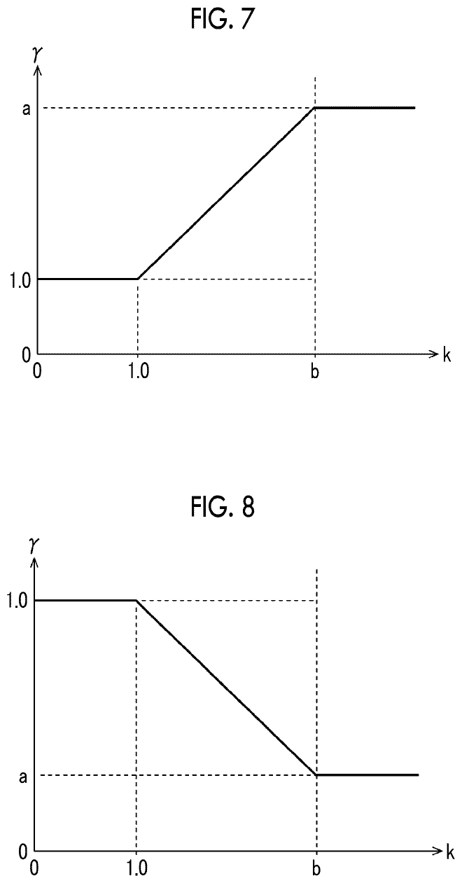

FIG. 7 illustrates an example of a graph illustrating an example of a function in a case where the gradation characteristic value in display is determined in accordance with the depth of a pixel. A horizontal axis expresses a value of a distance coefficient k defined by Expression (4), and a vertical axis expresses a gradation characteristic value γ.

$$\begin{matrix}\begin{matrix}In a case where \\ x \leq L ,\end{matrix} & k = \frac{L - x}{{D}_{f}} \\ \begin{matrix}In a case where \\ x > L ,\end{matrix} & k = \frac{x - L}{{D}_{r}}\end{matrix} \} \qquad Expression ( 4 )$$

Here, L−x in a case where x≤L and x−L in a case where x>L are distances in the depth direction from the focus position for the subject at a distance of x. The distance coefficient k is a value obtained by normalizing the distance in the depth direction (|L−x|) from the focus position of the subject by Dᵣ or Dᵣ that is the depth of field. The gradation characteristic value y is determined by the conditional expression of Expression (5) in accordance with the value of the distance coefficient k.

$$γ = \{ \begin{matrix}1. & ( k \leq 1 ) \\ \frac{a - 1}{b - 1} ( k - 1 ) + 1 & ( 1 < k < b ) \\ a & ( k \leq b )\end{matrix} \qquad Expression ( 5 )$$

Here,
γ: gradation characteristic value,
a: set gradation characteristic value,
b: set distance coefficient, and
k: distance coefficient.

The set gradation characteristic value a in Expression (5) is a value set as an upper limit value or a lower limit value of the variable gradation characteristic value γ, and is a value of a≠1. The set gradation characteristic value a is determined by, for example, average brightness of the region within the range of the depth of field in the image. Alternatively, the set gradation characteristic value a is set in advance by the user designation. The average brightness can be calculated as an average value of pixel values of the target region. The average brightness is an example of an index value related to the brightness of the region within the range of the depth of field. Instead of the average brightness, for example, other representative values, such as a median value or a mode value, or a new index value defined by combining a plurality of statistical values, may be used. The set distance coefficient b is a predetermined fixed value, and is a value greater than 1. The set distance coefficient b is set in accordance with the F number.

FIG. 7 is a graph illustrating an example of a function (Expression (5)) for determining the gradation characteristic value γ in a case where a>1. The set gradation characteristic value a in this case defines the upper limit value of the variable gradation characteristic value γ. According to FIG. 7, γ=1.0 is applied to the region within the range of the depth of field (0≤k≤1), and the gradation characteristic value γ that satisfies 1<γ≤a is applied to the region outside the range of the depth of field (1<k). Therefore, the region outside the range of the depth of field (1<k) is displayed relatively brighter than the region within the range of the depth of field.

FIG. 8 is a graph illustrating an example of a function for determining the gradation characteristic value γ in a case where a<1. The set gradation characteristic value a in this case defines the lower limit value of the variable gradation characteristic value γ. According to FIG. 8, γ=1.0 is applied to the region within the range of the depth of field (0≤k≤1), and the gradation characteristic value γ that satisfies a≤γ<1 is applied to the region outside the range of the depth of field (1<k). Therefore, the region outside the range of the depth of field (1<k) is displayed relatively darker than the region within the range of the depth of field.

By changing the gradation characteristic value γ in accordance with Expression (5), a difference between large blurriness and small blurriness is easily understood in the displayed image, and a person who captures an image can easily adjust the focus. In FIGS. 7 and 8, an example is illustrated in which γ is changed linearly in a range of 1<k, but γ may be changed nonlinearly with respect to k.

### Example of Changing Gradation Characteristics in Accordance with F Number

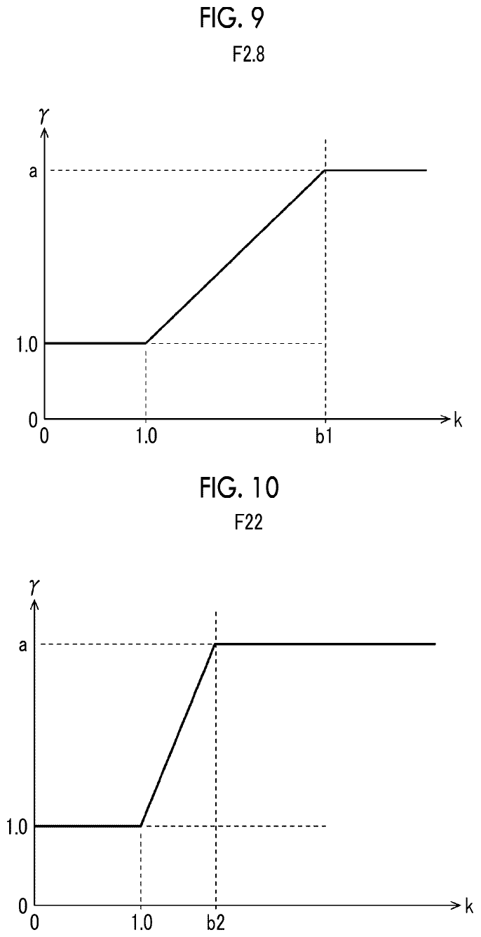

Since the depth of field changes depending on the value of the F number F, the processor 4 changes the gradation characteristics in accordance with the F number F. FIGS. 9 and 10 are graphs illustrating an example of a case where the gradation characteristics are changed in accordance with the F number. FIG. 9 is a graph illustrating an example of the gradation characteristic value applied in a case where the F number is F2.8, and FIG. 10 is a graph illustrating an example of the gradation characteristic value applied in a case where the F number is F22. The set distance coefficient b1 set in a case of F2.8 is set to a value (b1>b2) greater than the set distance coefficient b2 set in a case of F22.

Since, as the F number is greater, the depth of field is deeper, and the distance range in the depth direction outside the range of the depth of field is narrower, as illustrated in FIGS. 9 and 10, the processor 4 changes the brightness of the region outside the range of the depth of field more drastically with respect to the change of k as the F number is greater. Although F2.8 and F22 are illustrated as examples in FIGS. 9 and 10, the set distance coefficient b in accordance with the F number is set in the same manner for other F numbers, and the set distance coefficient b is set to a smaller value as the F number is greater. In addition, although an example of a>1 is illustrated in FIGS. 9 and 10, the brightness is changed more drastically with respect to the change of k in the region outside the range of the depth of field as the F number becomes greater, as in a case of a<1. As a result, it is possible to improve the visibility of the region within the range of the depth of field.

### Configuration Example of Imaging Element

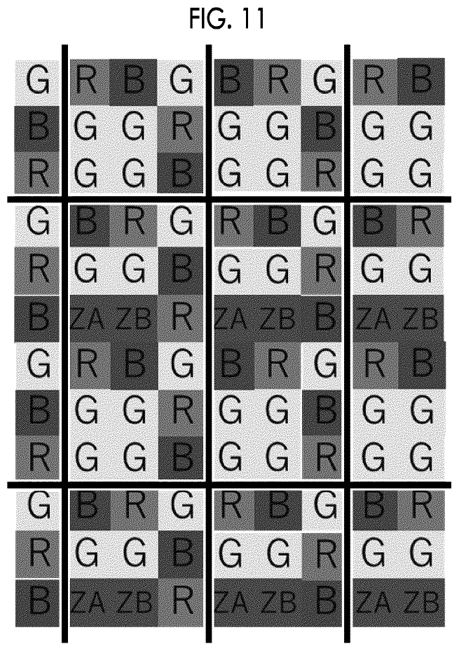

FIG. 11 is a diagram illustrating a configuration example of the imaging element 26. FIG. 11 illustrates an example of a color filter array and the disposition of the phase difference pixels of the imaging element 26. In the imaging element 26, color filters of R, G, and B are disposed in a periodic color arrangement on a plurality of pixels composed of photoelectric conversion elements (photodiodes) two-dimensionally arranged in a first direction (horizontal direction) and a second direction (vertical direction) orthogonal to the first direction, and the microlens is disposed on each photodiode.

In the imaging element 26, a plurality of phase difference pixels for phase difference detection and a plurality of normal pixels for imaging are disposed. The phase difference pixels include two types of pixels, that is, a first phase difference pixel ZA and a second phase difference pixel ZB. The normal pixel refers to a pixel other than the phase difference pixel. In the plurality of normal pixels, any color filter of a first filter corresponding to a first color (green) or a plurality of second filters corresponding to each of two or more colors (red and blue) other than green are disposed in a periodic color arrangement.

The color filter array illustrated in FIG. 11 is an X-Trans (registered trademark) array. In the X-Trans (registered trademark) array, a red filter (R filter) that transmits a red (R) wavelength range, a blue filter (B filter) that transmits a blue (B) wavelength range, and a green filter (G filter) that transmits a green (G) wavelength range are arranged with predetermined periodicity. In addition, the periodic color arrangement is not limited to the X-Trans (registered trademark) array, and may be another color filter array such as a Bayer array.

The imaging element 26 includes a phase difference pixel row in which the phase difference pixels are disposed, and a normal pixel row in which only the normal pixels are disposed. In the example illustrated in FIG. 11, the sixth row and the twelfth row (bottom row) correspond to the phase difference pixel row. Although only a part of the pixel disposition of the imaging element 26 is illustrated in FIG. 11, the phase difference pixel row is provided to be distributed over the entire sensor surface at regular intervals (with a plurality of normal pixel rows interposed therebetween).

The phase difference pixels consist of the first phase difference pixel ZA and the second phase difference pixel ZB each having an opening portion for pupil division and having positions of the opening portions different from each other in the horizontal direction, and a pair of the first phase difference pixels ZA and the second phase difference pixels ZB are adjacent to each other with the opening portions facing each other. The first phase difference pixel ZA is a right opening pixel having the opening portion in a right half of the pixel, and the second phase difference pixel ZB is a left opening pixel having the opening portion in a left half of the pixel.

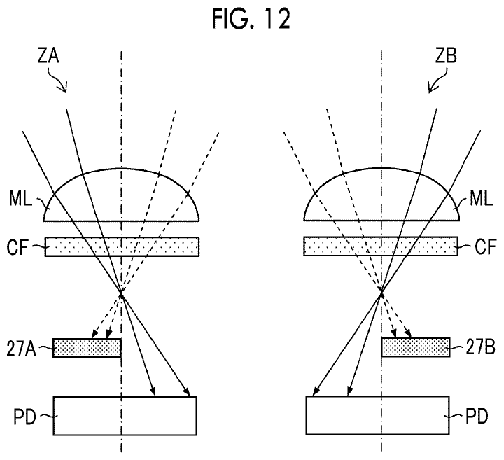

FIG. 12 is an enlarged view of a main part illustrating a configuration example of the phase difference pixel. As illustrated in FIG. 12, a light-shielding film 27A is disposed on a front surface side (microlens ML side) of the photodiode PD of the first phase difference pixel ZA, and a light-shielding film 27B is disposed on a front surface side of the photodiode PD of the second phase difference pixel ZB. In addition, as a color filter CF, the G filter is disposed below the microlens ML. The microlens ML and the light-shielding films 27A and 27B have a pupil division function, and in FIG. 12, the light-shielding film 27A shields a left half of a light-receiving surface of the photodiode PD. Therefore, in the first phase difference pixel ZA, only a luminous flux passing through a left side of an optical axis among luminous fluxes passing through the exit pupil of the lens 20 of the imaging optical system 24 is received.

The light-shielding film 27B shields a right half of the light-receiving surface of the photodiode PD of the second phase difference pixel ZB. Therefore, in the second phase difference pixel ZB, only a luminous flux passing through a right side of the optical axis among luminous fluxes passing through the exit pupil of the imaging optical system 24 is received. As described above, the luminous flux passing through the exit pupil is divided into left and right by the microlens ML and the light-shielding films 27A and 27B having the pupil division function, and the divided luminous fluxes are incident on the first phase difference pixel ZA and the second phase difference pixel ZB, respectively.

The processor 4 calculates an amount of deviation of the focus from the perfect focus using the information obtained from the first phase difference pixel ZA and the second phase difference pixel ZB, and performs an AF process by a so-called image plane phase difference autofocus (AF) method. In addition, the processor 4 converts the amount of deviation from the perfect focus into the depth to obtain the pixel depth.

### Example of Method of Obtaining Depth Information of Pixel

The processor 4 estimates the pixel depth of the normal pixel based on the pixel depth obtained for the pixel position of the phase difference pixel. For example, the processor 4 may apply the amount of deviation calculated from the phase difference pixels (ZA and ZB) that are all included in the pixel block of 6×3 in a frame surrounded by a thick solid line in FIGS. 11 to 18 pixels included in the pixel block, and use the amount of deviation as the pixel depth of each pixel. Alternatively, the processor 4 may calculate the pixel depths of the normal pixels (R pixel, G pixel, and B pixel) by an interpolation calculation from the depths of the plurality of surrounding phase difference pixels.

The processor 4 may calculate the subject distance value, that is, the depth corresponding to the pixel in the image IM using a trained model that has been trained in advance on a relationship between the information on the phase difference pixel and the subject distance value. The processor 4 may acquire the depth information of each pixel by using artificial intelligence (AI) to which a trained model that has been trained by machine learning to output the depth in the pixel in response to the input of the information on the phase difference pixel is applied.

The processor 4 is not limited to the aspect in which the depth in each pixel is obtained using the AI, and the amount of deviation from the perfect focus may be calculated based on the information on the phase difference pixel without using the AI. However, since there is a concern that sufficient accuracy cannot be obtained with only one set of phase difference pixels, it is desirable to calculate the amount of deviation in a certain block (pixel group) including the plurality of phase difference pixels in a case where the AI is not used.

### Example of Changing Display Brightness According to Brightness of Region within Range of Depth of Field

In the default setting of the display control device 2, the processor 4 is set to determine the display brightness of the region outside the range of the depth of field in accordance with a representative value of the region within the range of the depth of field. The representative value is a representative value of the index value (for example, the brightness value) related to the brightness. The representative value is a value expressing features of the entire data, such as an average value, a median value, and a mode value. In the default setting, the processor 4 acquires the region of the main subject in the image IM, and changes and displays the display brightness of the region outside the range of the depth of field in accordance with the brightness (brightness) of the region of the main subject within the range of the depth of field. For example, in the default setting, in a case where the average brightness of the region within the range of the depth of field is greater than the first threshold value, the set gradation characteristic value a satisfying a<1 is set, and the gradation characteristic value γ applied to the conversion of the pixel value of the region outside the range of the depth of field is set to γ<1. In this case, the value of a may be set to, for example, 0.40.

In addition, in a case where the average brightness of the region within the range of the depth of field is less than the first threshold value, the set gradation characteristic value a satisfying a>1 is set, and the gradation characteristic value γ applied to the conversion of the pixel value of the region outside the range of the depth of field is set to γ>1. In this case, the value of a may be set to, for example, 2.5. The first threshold value compared with the average brightness may be, for example, 127.5 that is a central value of 256 gradations.

As described above, by changing the gradation characteristic value γ for the region outside the range of the depth of field in accordance with the index value related to the brightness of the region within the range of the depth of field, the density difference between the region within the range of the depth of field and the region outside the range of the depth of field can be increased.

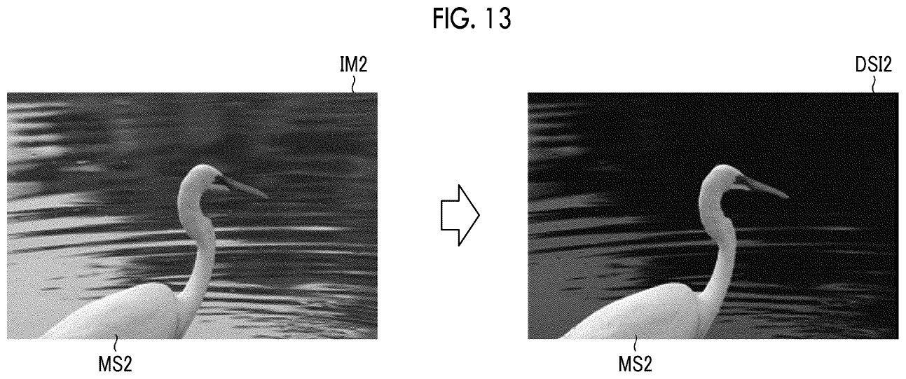

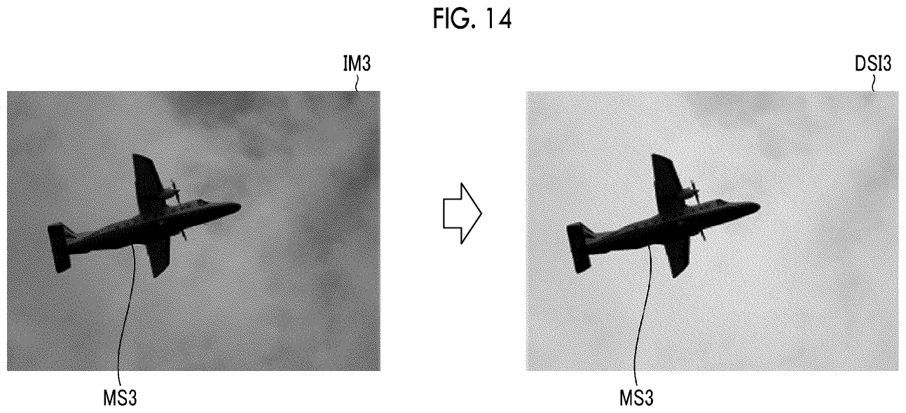

FIGS. 13 and 14 are examples of the display image in which the display brightness of the region outside the range of the depth of field is changed and displayed in accordance with the brightness of the region within the range of the depth of field in the image. FIG. 13 is an example of a display image DSI2 generated in a case where the brightness of the region within the range of the depth of field in an image IM2 is greater than the first threshold value. Since the region within the range of the depth of field of a main subject MS2 in the image IM2 has a large pixel value and is bright, it is preferable to change the gradation characteristics and perform the conversion of the pixel value such that the region outside the range of the depth of field in the image IM2 is displayed dark. The display image DSI2 illustrated in FIG. 13 is generated by applying Expression (5) in a case where the set gradation characteristic value a is set to a value less than 1, and the region outside the range of the depth of field is displayed darker than the original image IM2.

The region of the main subject MS2 within the range of the depth of field illustrated in FIG. 13 is an example of a “first region” according to the present disclosure. The region of the background other than the main subject MS2 illustrated in FIG. 13 is the region outside the range of the depth of field, and the region of the background is an example of a “second region” according to the present disclosure.

FIG. 14 is an example of a display image DSI3 generated in a case where the brightness of the region within the range of the depth of field in an image IM3 is less than the first threshold value. Since the region of a main subject MS3 within the range of the depth of field in the image IM3 has a small pixel value and is dark, it is preferable to change the gradation characteristics and perform the conversion of the pixel value such that the region outside the range of the depth of field in the image IM3 is displayed bright. The display image DSI3 illustrated in FIG. 14 is generated by applying Expression (5) in a case where the set gradation characteristic value a is set to a value greater than 1, and the region outside the range of the depth of field is displayed brighter than the original image IM3.

The region of the main subject MS3 within the range of the depth of field illustrated in FIG. 14 is an example of a “first region” according to the present disclosure. The region of the background other than the main subject MS3 illustrated in FIG. 14 is the region outside the range of the depth of field, and the region of the background is an example of a “second region” according to the present disclosure.

### Example of Setting Screen for Setting Display Brightness of Region Outside Range of Depth of Field

The configuration is preferable in which the user can freely set the display brightness of the region outside the range of the depth of field such that the display brightness can be set to the display brightness that is easy for the user to see, not limited to the change in the display brightness in accordance with the default setting described with reference to FIGS. 13 and 14. In a case of the configuration in which the user designates the display brightness of the region outside the range of the depth of field, the user may freely set the gradation value of the image in a range of 0 to 255, or designate the gradation characteristic value applied to the conversion of the pixel value of the region outside the range of the depth of field. For example, the processor 4 receives designation of gradation setting applied to the display of the region outside the range of the depth of field via the operation unit 18, and changes the gradation characteristics of the region other than the main subject in accordance with the designated gradation setting.

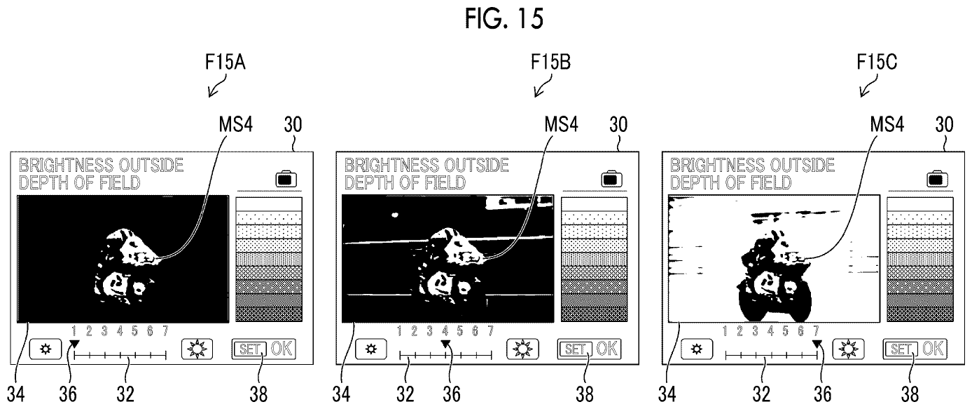

FIG. 15 is a diagram illustrating an example of an image brightness setting screen 30 for setting the display brightness of the region outside the range of the depth of field. A left diagram F15A illustrated in FIG. 15 illustrates a screen example in a case where the display brightness of the region outside the range of the depth of field is set to a level 1, which is the darkest level among seven levels, by a brightness adjustment bar 32 that can change the display brightness of the region outside the range of the depth of field in seven levels from a level 1 to a level 7. A central diagram F15B illustrated in FIG. 15 illustrates a screen example in a case where the display brightness is set to a level 4, and a right diagram F15C illustrates a screen example in a case where the display brightness is set to a level 7. The region of a main subject MS4 is a region within the range of the depth of field, and the region of the background other than the main subject MS4 is a region outside the range of the depth of field. The phrase “outside the depth of field” illustrated in FIG. 15 means outside the range of the depth of field.

As illustrated in FIG. 15, the image brightness setting screen 30 displays the brightness adjustment bar 32 below an image display area 34. An inverted triangular mark 36 displayed above the brightness adjustment bar 32 indicates the currently selected level. Each of the levels from the level 1 to the level 7 may be determined, for example, in accordance with the seven types of gamma values illustrated in FIG. 6. An image set to the brightness of the currently selected level is displayed in the image display area 34. The user can check the image displayed in the image display area 34, and select a desired brightness level via the operation unit 18. After selecting the desired brightness level, the user can set the display brightness (brightness) of the region outside the range of the depth of field by pressing a set button 38. The user interface may be adopted in which a density conversion curve (gamma curve) can be freely designated, not limited to such a stepwise brightness setting method.

In addition, although not illustrated, a configuration may be adopted in which the display brightness is set in the same manner for the display of the region within the range of the depth of field including the main subject MS4. The setting of the display brightness of the region of the main subject MS4 may be the same as the user interface screen for setting the display brightness in a case where the image IM is displayed as it is on the display unit 16. [Description of Functional Configuration of Display Control Device]

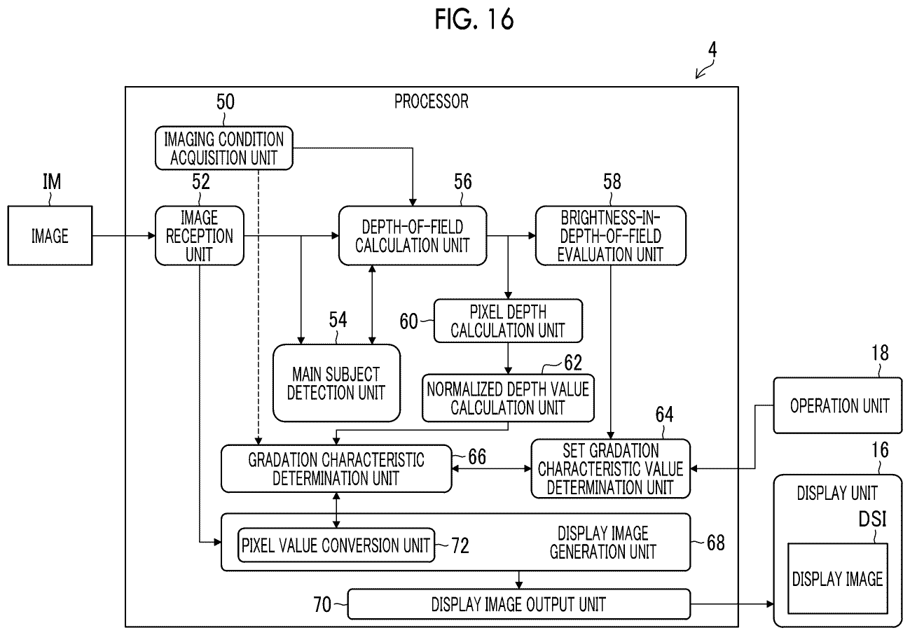

FIG. 16 is a block diagram illustrating a functional configuration of the display control device 2. The processor 4 functions as an imaging condition acquisition unit 50, an image reception unit 52, a main subject detection unit 54, a depth-of-field calculation unit 56, a brightness-in-depth-of-field evaluation unit 58, a pixel depth calculation unit 60, a normalized depth value calculation unit 62, a set gradation characteristic value determination unit 64, a gradation characteristic determination unit 66, a display image generation unit 68, and a display image output unit 70.

The imaging condition acquisition unit 50 acquires information on the imaging conditions of the image IM. The imaging conditions include the focal length, the F number, and the like required for calculating the depth of field. The image reception unit 52 receives the input of the image IM captured by the imaging element 26.

The main subject detection unit 54 acquires information on the region of the main subject in the image IM. The region of the main subject may be, for example, a region of a subject on which focusing has been performed by an AF function. The person who captures an image can select one or more of a plurality of focus points in the imaging field of view to perform focusing, and a region of the subject of the selected focus point may be detected as the region of the main subject. Further, the main subject detection unit 54 may detect a region of the subject in the AF area as the region of the main subject. Alternatively, the main subject detection unit 54 may detect a face region extracted by a face extraction process, as the region of the main subject.

In addition, the main subject detection unit 54 may detect the region of the subject detected by executing a process of subject detection AF as the region of the main subject. The subject detection AF is, for example, an AF function of specifying a type of a specific target object (subject) such as an animal, a bird, a car, a two-wheeled vehicle, an airplane, or a train in advance, and displaying a region of the detected target object with a frame in a case where the target subject is detected in a focus area or near the focus area, and performing focusing on the target object. The technology of detecting a specific target object from the image may apply, for example, an object detection algorithm using deep learning.

The depth-of-field calculation unit 56 calculates the depth of field based on the imaging condition information acquired via the imaging condition acquisition unit 50, and acquires the front depth of field D_{f}, the rear depth of field Dᵣ, and the subject distance L of the focus position.

The brightness-in-depth-of-field evaluation unit 58 evaluates the brightness of the region within the range of the depth of field in the image IM. The brightness-in-depth-of-field evaluation unit 58 obtains the index value related to the brightness, such as an average value (average brightness) of the pixel values of the region of the main subject within the range of the depth of field, and compares the index value with the first threshold value. The evaluation result of the brightness-in-depth-of-field evaluation unit 58 is provided to the set gradation characteristic value determination unit 64.

The set gradation characteristic value determination unit 64 determines the set gradation value based on the evaluation result of the brightness-in-depth-of-field evaluation unit 58. For example, the set gradation characteristic value determination unit 64 determines the set gradation characteristic value a that satisfies a<1 in a case where the index value indicates the brightness that is greater than the first threshold value, and determines the set gradation characteristic value a that satisfies a>1 in a case where the index value indicates the brightness that is less than the first threshold value. In addition, the set gradation characteristic value determination unit 64 may receive designation of the set gradation characteristic value a from the user via the operation unit 18, and apply the set gradation characteristic value a designated by the user.

The pixel depth calculation unit 60 calculates the depth of each pixel in the image IM. The pixel depth calculation unit 60 may obtain the depth by using the AI. The normalized depth value calculation unit 62 calculates the distance coefficient k indicating the depth value obtained by normalizing the distance in the depth direction from the focus position of the subject in the image IM by the depth of field in accordance with Expression (4).

The gradation characteristic determination unit 66 determines the gradation characteristics applied to the display of the image using Expression (5).

The display image generation unit 68 includes a pixel value conversion unit 72. The pixel value conversion unit 72 applies the gradation characteristics determined by the gradation characteristic determination unit 66 to convert the pixel value of the image IM. The pixel value conversion unit 72 functions as a brightness change unit that changes the display brightness of the image IM. A display image DSI is generated through the process of the pixel value conversion unit 72.

The display image output unit 70 performs a process of outputting the display image DSI. The display image output unit 70 converts the display image DSI into a signal format suitable for display on the display unit 16, and outputs the display image DSI to the display unit 16. As described above, the display image DSI is displayed on the display unit 16. In addition, the display control device 2 may be understood as an image processing device that processes the image IM.

### [Hardware Configuration of Each Processing Unit]

A hardware structure of a processing unit that executes various processes, such as the imaging condition acquisition unit 50, the image reception unit 52, the main subject detection unit 54, the depth-of-field calculation unit 56, the brightness-in-depth-of-field evaluation unit 58, the pixel depth calculation unit 60, the normalized depth value calculation unit 62, the set gradation characteristic value determination unit 64, the gradation characteristic determination unit 66, the display image generation unit 68, the pixel value conversion unit 72, and the display image output unit 70, described with reference to FIG. 16, is various processors as described below.

The various processors include the CPU that is a general-purpose processor that executes the program and functions as the various processing units, the GPU that is a processor specialized in the image processing, a programmable logic device (PLD) that is a processor whose circuit configuration can be changed after manufacture, such as a field programmable gate array (FPGA), and a dedicated electric circuit that is a processor having a circuit configuration designed for exclusive use to execute a specific process, such as an application specific integrated circuit (ASIC).

One processing unit may be configured by one of these various processors or two or more processors of the same type or different types. One processing unit may be configured by, for example, a plurality of FPGAs, a combination of a CPU and an FPGA, or a combination of a CPU and a GPU. Furthermore, a plurality of processing units may be configured by one processor. As an example in which the plurality of processing units are configured by one processor, first, there is a form in which one processor is configured by a combination of one or more CPUs and software, and this processor functions as the plurality of processing units, as typified by a computer, such as a client or a server. Second, there is a form in which a processor is used, which achieves the functions of the entire system including the plurality of processing units with one integrated circuit (IC) chip, as typified by a system on a chip (SoC) or the like.

Various processing units are configured by one or more of the various processors as the hardware structure as described above.

Furthermore, the hardware structure of these various processors is, more specifically, an electric circuit (circuitry) in which the circuit elements, such as semiconductor elements, are combined.

### Example of Process of Changing Brightness of Image in Live View Display

Here, as an example of the display control by the display control device 2, an example of a process of changing the brightness of the image in live view display of the digital camera will be described.

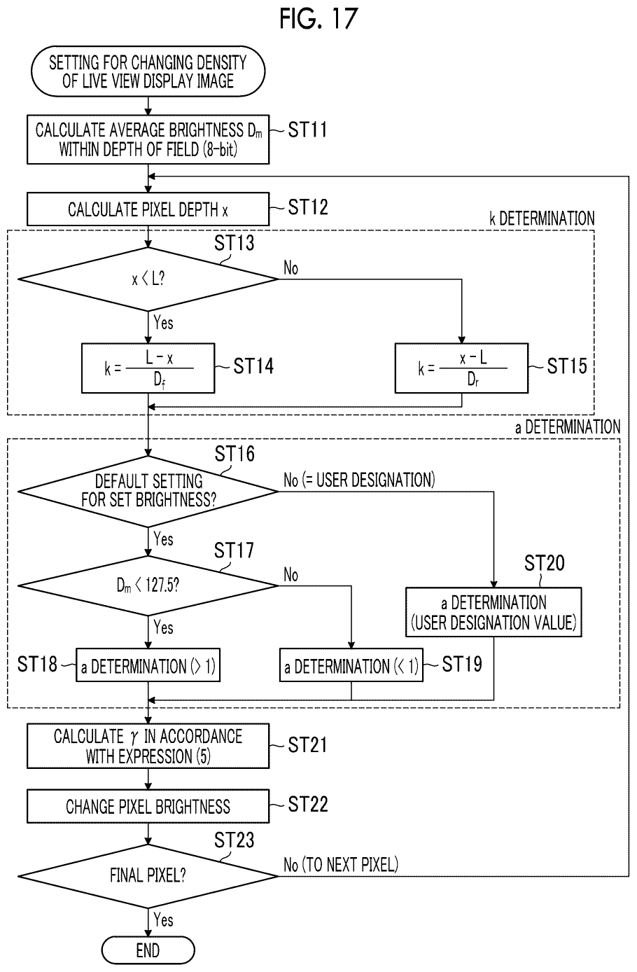

FIG. 17 is a flowchart illustrating an example of the process of changing the brightness of the image in the live view display.

In step ST11, the processor 4 acquires information on the depth of field and the focus position of the captured image IM, and calculates an average brightness Dm of the region within the range of the depth of field in the image. The average brightness Dm may be expressed using, for example, 8-bit gradations. The average brightness Dm is an example of an index for evaluating the brightness (brightness) of the region within the depth of field range.

In step ST12, the processor 4 calculates the pixel depth x that is the distance in the depth direction of the subject corresponding to the target pixel in the image IM.

In step ST13, the processor 4 determines whether or not the pixel depth x is less than the subject distance L of the focus position (x<L). In a case where the determination result in step ST13 is Yes, the processor 4 proceeds to step ST14.

In step ST14, the processor 4 calculates the distance coefficient k by the expression of k=(L−x)/D_{f}.

On the other hand, in a case where the determination result in step ST13 is No, the processor 4 proceeds to step ST15. In step ST15, the processor 4 calculates the distance coefficient k by the expression of k=(x−L)/Dᵣ. Steps ST13 to ST15 are operations for determining the distance coefficient k of the target pixel.

After step ST14 or step ST15, the processor 4 proceeds to step ST16. In step ST16, the processor 4 determines whether or not to apply the default setting for the set brightness.

In a case where the determination result in step ST16 is Yes, that is, in a case where the default setting is adopted for the set brightness in a case of displaying the live view image, the processor 4 proceeds to step ST17.

In step ST17, the processor 4 determines whether or not the average brightness Dm of the region within the range of the depth of field in the image IM is less than the first threshold value. For example, the processor 4 determines whether or not the average brightness Dm expressed using 8-bit gradations is less than 127.5 of the first threshold value. In a case where the determination result in step ST17 is Yes, that is, in a case where the brightness of the region within the range of the depth of field is less than the first threshold value, the processor 4 proceeds to step ST18.

In step ST18, the processor 4 determines a value that satisfies a>1 as the set gradation characteristic value a.

On the other hand, in a case where the determination result in step ST17 is No, that is, in a case where the brightness of the region within the range of the depth of field is greater than the first threshold value, the processor 4 proceeds to step ST19.

In step ST19, the processor 4 determines a value that satisfies a<1 as the set gradation characteristic value a.

In a case where the determination result in step ST16 is No, that is, in a case where the user performs a setting (designation by the user) different from the default setting for the set brightness in a case of displaying the live view image, the processor 4 proceeds to step ST20. In step ST20, the processor 4 determines a value (user designation value) designated by the user as the set gradation characteristic value a.

Steps ST16 to ST20 are operations for determining the set gradation characteristic value a. After step ST18, step ST19, or step ST20, the processor 4 proceeds to step ST21.

In step ST21, the processor 4 calculates the gradation characteristic value γ in accordance with Expression (5).

In step ST22, the processor 4 converts the pixel value (each signal value of RGB) of the target pixel using the gradation characteristic value γ determined in step ST21, and changes the brightness of the pixel. Steps ST12 to ST22 are executed in units of pixels of the image IM.

In step ST23, the processor 4 determines whether or not the process of the final pixel in the image IM is completed. In a case where the determination result in step ST23 is No, the processor 4 changes the target pixel to the next pixel, returns to step ST12, and repeats steps ST12 to ST23.

In a case where the process is completed for all pixels in the image IM and the determination result in step ST23 is Yes, the processor 4 ends the flowchart illustrated in FIG. 17.

In this manner, the display image DSI as the live view image is generated, and the display image DSI is displayed on the display unit 16. The process illustrated in the flowchart illustrated in FIG. 17 may be executed for each frame of the live view image.

It is preferable that the imaging system 10 is configured to switch between a first display method of performing display by applying the process of changing the brightness illustrated in the flowchart illustrated in FIG. 17 and a second display method of displaying the image IM (before the brightness change) without performing the process of changing the brightness, in response to the selection of the user. For example, a configuration may be adopted in which the user can select the first display method or the second display method on a menu screen for performing various settings of the imaging system 10.

The processor 4 may, for example, receive a selection of whether or not to execute the process of changing the brightness from the operation unit 18, and in a case where the setting is made not to execute the process, may transition to a process flow of performing the display of the live view image by applying a known display control method to the image IM.

### Display Control Example in Case where Area Ratio of Region within Range of Depth of Field to Entire Screen is Large

In a case where a proportion (area ratio) of the region within the range of the depth of field in the image IM on the screen is equal to or greater than the second threshold value, the processor 4 may fix the gradation characteristic value γ applied to the display of the region outside the range of the depth of field to the set gradation characteristic value a, and change the gradation characteristic value γ applied to the display of the region within the range of the depth of field in accordance with the value of the distance coefficient k.

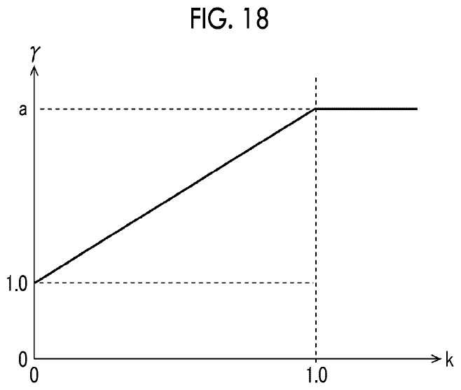

FIG. 18 is a graph illustrating an example of a function for determining the gradation characteristic value in a case where the area ratio of the region within the range of the depth of field in the image is equal to or greater than the second threshold value. For example, in a case where the proportion of the region within the range of the depth of field in the image IM on the screen is equal to or greater than the second threshold value, as illustrated in FIG. 18, the processor 4 may fix the gradation characteristic value γ applied to the pixel of the region outside the range of the depth of field to the set gradation characteristic value a, and linearly change the gradation characteristic value γ applied to the pixel of the region within the range of the depth of field with respect to the distance coefficient k.

As a result, in a case where many subjects are present within the range of the depth of field, the focus position can be known in more detail. In FIG. 18, γ is changed linearly in a range of 0≤k≤1, but may be changed nonlinearly.

### Example of Method of Acquiring Depth Information of Pixel Using Information on Phase Difference Pixel

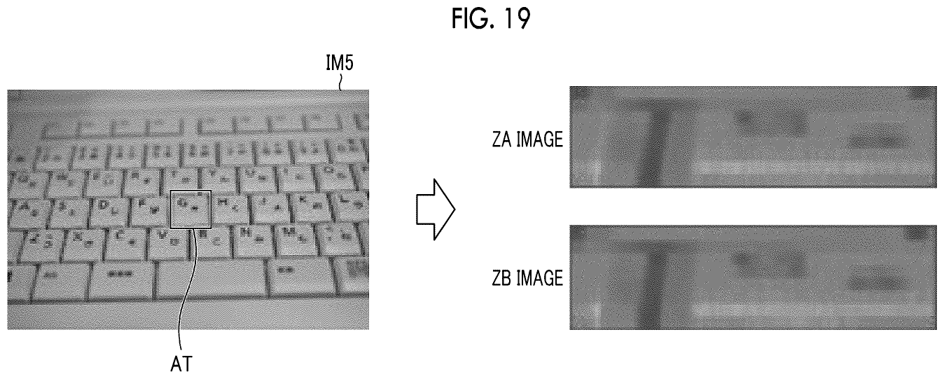

FIG. 19 is a diagram illustrating an example of an image IM5 captured by the imaging element 26 including the phase difference pixel and an example of a phase difference image obtained from the phase difference pixel. A rectangular frame AT in the image IM5 is an AF target indicating a portion to be focused. A ZA image illustrated on the right side illustrated in FIG. 19 is a first phase difference image obtained from information on the plurality of first phase difference pixels ZA, and a ZB image is a second phase difference image obtained from information on the plurality of second phase difference pixels ZB.

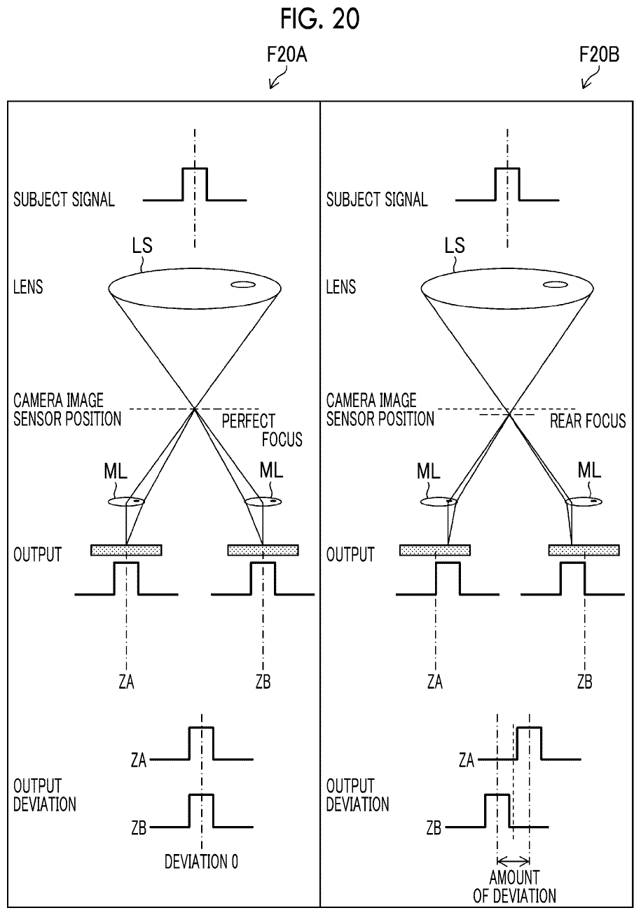

FIG. 20 is a diagram schematically illustrating the operation principle of the image plane phase difference AF using the phase difference pixel. A left diagram F20A illustrated in FIG. 20 illustrates a state of the perfect focus (focusing), and a right diagram F20B illustrates a state of the back focus. Here, as illustrated in the uppermost part illustrated in FIG. 20, an example of a case where a pattern of the subject is expressed using a rectangular signal and the center of the pattern and the center of the lens LS match each other will be described.

In a state of the perfect focus (left diagram F20A), in FIG. 20, the light passing through the right side of the lens LS and the light passing through the left side of the lens LS are focused at the same position on the image plane of the imaging element 26, and the peak position corresponding to the subject in the signal (first phase difference image) of the ZA output obtained from the pixel group of the first phase difference pixel ZA and the peak position corresponding to the subject in the signal (second phase difference image) of the ZB output obtained from the pixel group of the second phase difference pixel ZB match each other. That is, the deviation of the outputs of the ZA output and the ZB output is 0.

On the other hand, in a state of the back focus (right diagram F20B), the light passing through the right side of the lens LS is projected to the right side on the image plane of the imaging element 26, and the light passing through the left side of the lens LS is projected to the left side on the image plane. As a result, the peak position corresponding to the subject in the signal of the ZA output obtained from the pixel group of the first phase difference pixel ZA that captures the image of the light passing through the right side of the lens LS is shifted to the right side, and the peak position corresponding to the subject in the signal of the ZB output obtained from the pixel group of the second phase difference pixel ZB is shifted to the left side. Since the amount of deviation of the peak positions of the ZA output and the ZB output is correlated with the defocus amount, the defocus amount can be understood from the amount of deviation of the outputs of the phase difference pixels.

In a state of the front focus (not illustrated), the light passing through the right side of the lens LS is projected to the left side on the image plane of the imaging element 26, and the light passing through the left side of the lens LS is projected to the right side on the image plane. Therefore, the defocus direction indicating the front focus or the back focus and the defocus amount can be specified from a positional relationship of the peak positions of the ZA output and the ZB output. By moving the lens LS to the position of the perfect focus based on the defocus direction and the defocus amount specified in this manner, the target subject can be focused.

The processor 4 of the display control device 2 according to the present embodiment obtains the subject distance of the subject captured by each pixel, that is, the depth of each pixel, based on the amount of deviation understood from the phase difference image.

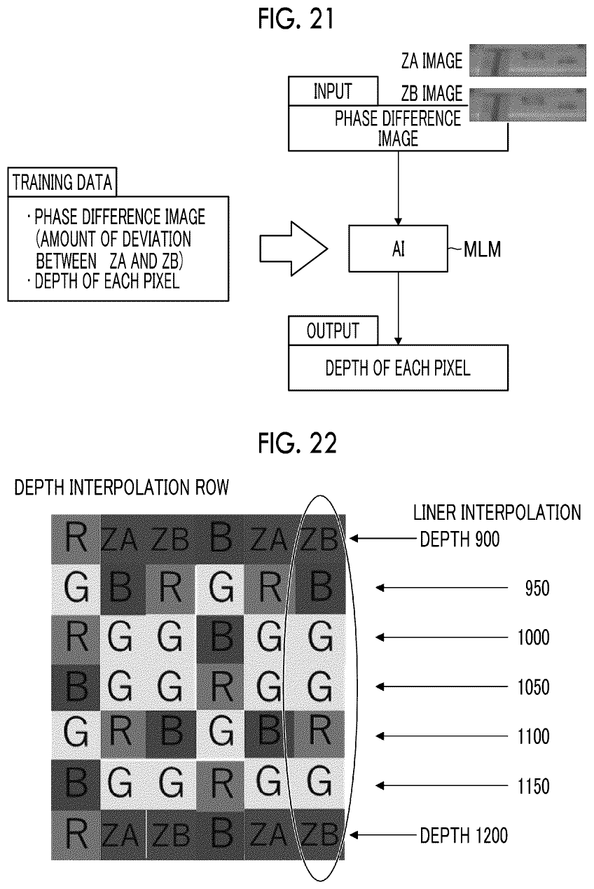

FIG. 21 is a diagram illustrating an outline of a phase difference pixel AI used for a process of estimating the depth of the pixel from the phase difference image. The phase difference pixel AI is AI that estimates the distance in the depth direction from the input information on the phase difference pixel, and outputs distance information (depth information). The phase difference pixel AI is configured by, for example, a machine learning model MLM that has been trained by machine learning to receive the amount of deviation between the phase difference pixels that are a pair as input and output the depth in each pixel. The machine learning model MLM is configured by, for example, a neural network. The machine learning algorithm may be, for example, deep learning. The machine learning model MLM is essentially a program.

In a training phase, the machine learning is performed using training data in which the phase difference image and the information on the depth of each pixel corresponding to the phase difference image are associated with each other, and parameters of the machine learning model MLM are optimized. The amount of deviation between the phase difference images that are a pair (ZA pixels and ZB pixels) extracted from the phase difference image is input to the machine learning model MLM, and an estimated value of the depth corresponding to the input amount of deviation is output from the machine learning model MLM. The parameters of the machine learning model MLM are updated such that the estimated value of the depth output from the machine learning model MLM approaches the depth of the ground truth of the training data. By repeating the training using a dataset in which a large amount of training data is collected, the parameters of the machine learning model MLM are optimized. As a result, a trained machine learning model MLM (that has been trained) is generated.

In an inference phase, the process of estimating the depth of each pixel from the input phase difference image is performed using the trained machine learning model MLM. The trained machine learning model MLM is an example of a “trained model” according to the present disclosure. The depths of the phase difference pixels (first phase difference pixel ZA and second phase difference pixel ZB) are the depths obtained as the outputs from the phase difference pixels AI.

For the normal pixels (R pixel, G pixel, and B pixel), the depth of each pixel is obtained by an interpolation calculation from the depths of the surrounding phase difference pixels.

FIG. 22 is a diagram illustrating an example of the depth interpolation calculation. For example, in a case where the value of the depth of the second phase difference pixel ZB disposed in the first row and the sixth column (rightmost column) illustrated in FIG. 22 is 900, and the value of the depth of the second phase difference pixel ZB disposed in the sixth row and the sixth column is 1200, the value of the depth may be obtained by linear interpolation for the normal pixels (B, G, G, R, and G pixels from the second row to the fifth row of the sixth column) disposed between these pixels. The value of the depth may be, for example, a value expressed using a physical unit such as millimeters, or a value of an appropriate scale that can be converted into a value (physical quantity) of the physical unit.

As described with reference to FIGS. 21 and 22, by using the phase difference pixel AI, the depth can be estimated from the surrounding information even in an image region having no (or few) features as patterns, such as a low-contrast region. Since the depth can be estimated for each phase difference pixel by using the AI, it is possible to change the brightness with high resolution.

### Specific Example of Imaging System 10

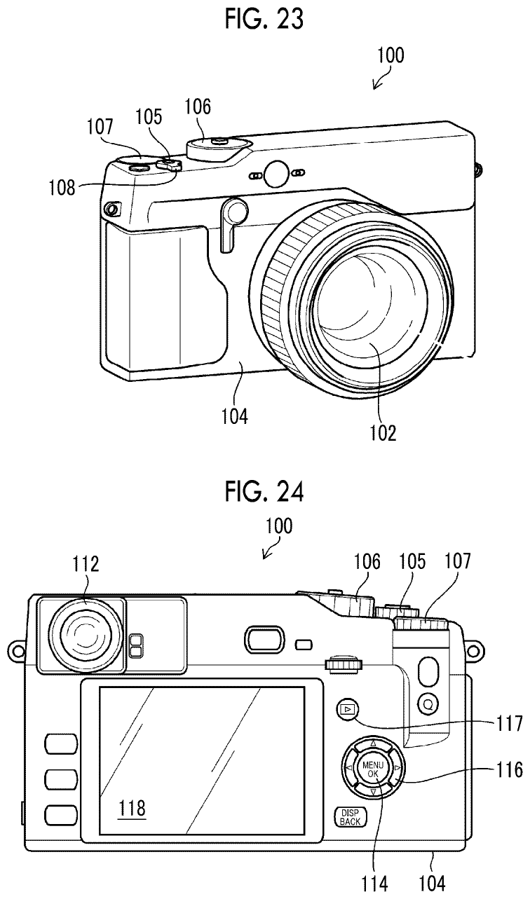

A further specific example of the imaging system 10 according to the embodiment of the present disclosure will be described. FIGS. 23 and 24 illustrate a camera 100 as an example of the imaging system 10. FIG. 23 is a perspective view of the camera 100 as viewed obliquely from the front, and FIG. 24 is a rear view of the camera 100 illustrated in FIG. 23.

The camera 100 is a mirrorless digital single-lens camera having an interchangeable lens 102 and a camera body 104 to which the interchangeable lens 102 is attachable and detachable.

A body mount (not illustrated) to which the interchangeable lens 102 is mounted is provided on the front surface of the camera body 104. A shutter release button 105, a shutter speed dial 106, an exposure correction dial 107, a power lever 108, and the like are provided on the upper surface of the camera body 104.

In addition, as illustrated in FIG. 24, an electronic view finder (EVF) 112, a MENU/OK key 114, a cross key 116, a play button 117, a liquid crystal display (LCD) 118, and the like are provided on the rear surface of the camera body 104.

The LCD 118 functions as a display that displays the live view image in an imaging mode, that plays and displays the image captured in a playback mode, and that displays various menu screens. In a case where the eye is brought close to the EVF 112 in the imaging mode, the display is automatically switched to the EVF 112 by the operation of an eye sensor (not illustrated), and the display is switched to the LCD 118 in a case where the eye is moved away.

The MENU/OK key 114 is an operation key having both a function as a menu button for performing an instruction to display a menu on a screen of the LCD 118 and a function as an OK button for performing an instruction to confirm, execute, and the like of the selected content.

The cross key 116 is an operation unit that inputs instructions in four directions of up, down, left, and right, and functions as a button for selecting an item from a menu screen or issuing an instruction to select various setting items from each menu. In addition, an up key and a down key of the cross key 116 function as a zoom switch in the imaging or a playback zoom switch in the playback mode, and a left key and a right key function as a frame advance (forward and reverse) button in the playback mode. The play button 117 is a button for switching to the playback mode in which the still image or the video that has been captured and recorded is displayed on the LCD 118.

### [Internal Configuration of Camera 100]

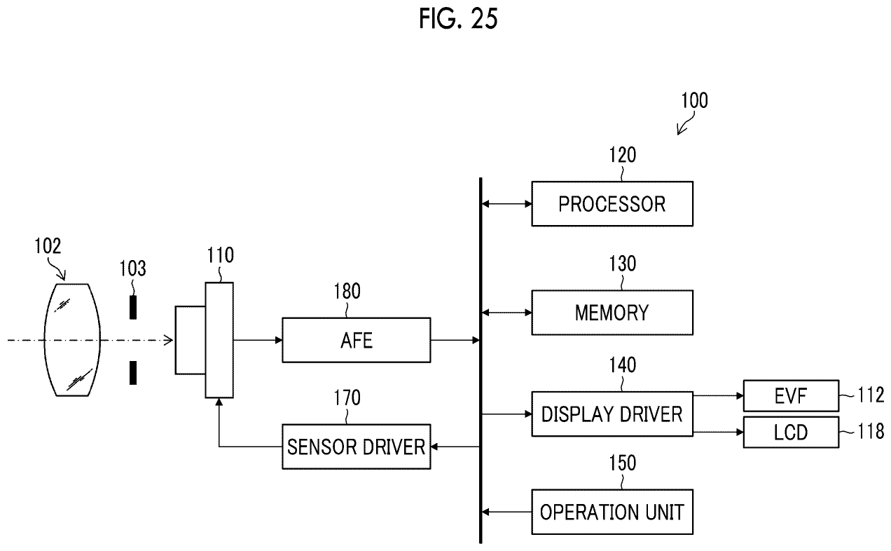

FIG. 25 is a block diagram illustrating an example of an internal configuration of the camera 100. As illustrated in FIG. 25, the camera 100 comprises an image sensor 110, a processor 120, a memory 130, a display driver 140, an operation unit 150, a sensor driver 170, and an analog front end (AFE) 180. The image sensor 110, the processor 120, the memory 130, and the operation unit 150 correspond to the imaging element 26, the processor 4, the storage device 6, and the operation unit 18 illustrated in FIG. 1, respectively. That is, the camera 100 is the imaging device equipped with the display control device 2.

The image sensor 110 is configured by a complementary metal-oxide-semiconductor (CMOS) type color image sensor. In addition, the image sensor 110 is not limited to the CMOS type, and may be a CCD type image sensor.

The interchangeable lens 102 comprises a stop 103, and corresponds to the imaging optical system 24 illustrated in FIG. 1. The optical image of the subject formed on the light-receiving surface of the image sensor 110 by the interchangeable lens 102 including the stop 103 is converted into the electric signal by the image sensor 110. In each pixel of the image sensor 110, electric charge corresponding to the amount of incident light is accumulated, and an electric signal corresponding to the amount of electric charge (signal charge) accumulated in each pixel is read out from the image sensor 110 as the image signal.

The processor 120 performs overall control of the units of the camera 100 in response to the user operation using the operation unit 150, and performs various processes. The processes performed by the processor 120 include a process of determining the gradation characteristics for displaying the image.

The memory 130 stores the command to be executed by the processor 120. The memory 130 includes a flash memory (not illustrated), a random access memory (RAM) (not illustrated), and a read only memory (ROM) (not illustrated). The memory 130 includes a memory card attachable to and detachable from the camera body 104.

The flash memory and the ROM are non-volatile memories that store firmware, various programs including a display control program according to the embodiment of the present disclosure, the captured images (still image and video), and the like.

The RAM functions as a work area for the processes by the processor 120, and temporarily stores firmware, a gradation characteristic determination program, and the like stored in the non-volatile memory. A portion (RAM) of the memory 130 may be provided in the processor 120.

The display driver 140 converts the input digital image signal into the signal format for display, and sequentially outputs the converted signal to the EVF 112 or the LCD 118. A part or some of the processing functions of the display driver 140 may be included in the processor 120. The EVF 112 and the LCD 118 correspond to the display unit 16 illustrated in FIG. 1.

The operation unit 150 includes the shutter release button 105, the shutter speed dial 106, the exposure correction dial 107, the power lever 108, the MENU/OK key 114, the cross key 116, the play button 117, and the like illustrated in FIGS. 23 and 24.

The sensor driver 170 performs control of reading out the image signal from the image sensor 110 in response to a command of the processor 120. The sensor driver 170 has an electronic shutter function of discharging (resetting) the electric charge accumulated in each pixel of the image sensor 110 by an electronic shutter control signal from the processor 120 to start exposure.

The AFE 180 performs various types of analog signal processing on the analog image signal obtained by imaging the subject with the image sensor 110, and converts the image signal after the analog processing into the digital image signal. The analog process in the AFE 180 includes, for example, a color separation process, and automatic gain control (AGC). The AGC functions as a sensitivity adjustment unit that adjusts the sensitivity during the imaging, and adjusts the gain of an amplifier that amplifies the input image signal such that the signal level of the image signal falls within an appropriate range. The sensitivity during the imaging may be, for example, an International Organization for Standardization (ISO) sensitivity.

The image data (mosaic image data) for each pixel of RGB output through the image sensor 110 and the AFE 180 in a case of capturing the still image or the video is input to the memory 130, and is temporarily stored. In a case where the image sensor 110 is a CMOS type image sensor, the AFE 180 is often built in the image sensor 110.

The processor 120 functions as a digital signal processing unit that performs various types of digital signal processing on the image data temporarily stored in the memory 130. That is, the processor 120 performs digital signal processing such as an offset process, a gain control process including sensitivity correction, a gamma correction process, a demosaicing process, an RGB/YCrCb conversion process on the image data input through the AFE 180, and stores the image data after the digital signal processing again in the memory 130. The demosaicing process is a process of, for example, calculating color information of all the RGB for each pixel from a mosaic image consisting of RGB in a case of the image sensor 110 consisting of the color filters of RGB three colors, and generates synchronized three-plane RGB image data from mosaic data (dot-sequential RGB data). The demosaicing process is also referred to as demosaicing or synchronization.

The RGB/YCrCb conversion process is a process of converting the synchronized RGB data into brightness data (Y) and color difference data (Cr and Cb).

Further, the processor 120 performs a compression process on the uncompressed brightness data Y and color difference data Cb and Cr temporarily stored in the RAM of the memory 130 in a case where the still image or the video is recorded. The still image is compressed into, for example, a joint photographic coding experts group (JPEG) format, and the video is compressed into, for example, an H.264 format. The compressed image data is recorded in the flash memory of the memory 130. The processor 120 reads out the compressed image data from the flash memory of the memory 130 in the playback mode, performs a decompression process on the read-out image data to generate uncompressed image data, and displays the uncompressed image data on the LCD 118 or the like via the display driver 140.

In a case where the live view image is displayed on the EVF 112 or the LCD 118, the processor 120 outputs the digital image signal, which is captured at a predetermined frame rate and digitally processed, to the display driver 140. Examples of the frame rate include 30 frames per second (fps) or 60 fps.

The display driver 140 converts the input time-series digital image signal into the signal format for display, and sequentially outputs the converted signal to the EVF 112 or the LCD 118. Accordingly, the captured image is displayed in real time on the EVF 112 or the LCD 118.

The shutter release button 105 is an imaging instruction unit for inputting an instruction to capture the still image and the video, and is configured by a two-stage stroke type switch consisting of so-called “half push” (S1 push) and “full push” (S2 push).

An S1_ON signal is output by the “half push” of the shutter release button 105, and an S2_ON signal is output by the “full push” of further pushing the shutter release button 105 from the “half push”. In a case of the still image capturing mode, in a case where the S1_ON signal is output, the processor 120 executes an imaging preparation process such as autofocus (AF) control and auto exposure (AE) control, and in a case where the S2_ON signal is output, the processor 120 executes a still image capturing process and a recording process.

In a case where the AF control is performed, the processor 120 calculates a numerical value required for the AF control based on the digital image signal. In a case of the image plane phase difference AF, the defocus amount is detected based on the pixel data of the phase difference pixel provided in the image sensor 110, and the focus lens is moved such that the defocus amount becomes zero. The method of the AF is not limited to the image plane phase difference AF, and, for example, other AF methods such as contrast AF may be adopted. In a case of the contrast AF, for example, an integrated value (focus evaluation value) of a high-frequency component of a G signal in a predetermined AF area is calculated. The processor 120 moves the focus lens included in the lens group of the interchangeable lens 102 to a position at which the focus evaluation value is maximized (that is, a position at which the contrast is maximized) during the AF control.

In a case of performing the AE control, the processor 120 detects the brightness of the subject (subject brightness), and calculates an exposure value that is a numerical value required for the AE control corresponding to the subject brightness. The exposure value is also referred to as an EV value. The processor 120 can determine the F-number (F number), the shutter speed, and the ISO sensitivity from a predetermined program diagram based on the calculated EV value, and perform the AE control.

It goes without saying that the AF control and the AE control are automatically performed in a case where an auto mode is set by the operation unit 150, and the AF control and the AE control are not performed in a case where a manual mode is set.

In a case of a video capturing mode, in a case where the S2_ON signal is output by the full push of the shutter release button 105, the camera body 104 is switched to a video recording mode in which the recording of the video is started, and the image processing and the recording process of the video are executed, and, in a case where the S2_ON signal is output by the full push of the shutter release button 105 again, the camera body 104 is switched to a standby state, and the recording process of the video is temporarily stopped.

In a case where the power is applied to the camera 100 configured in this way, the camera 100 enters an imaging standby state. In the imaging standby state, the camera 100 starts capturing the video. The captured video is displayed as the live view image on the EVF 112 or the LCD 118.

The user can visually recognize the live view image displayed on the EVF 112 or the LCD 118 to determine the composition, check the subject to be captured, or set the imaging conditions. The processor 120 executes the process as the display control device 2 described with reference to FIGS. 2 to 18.

### [Program Causing Computer to Implement Functions of Display Control Device 2]

A program causing the computer to implement a part or some of the processing functions of the display control device 2 according to the above embodiment can be recorded on a tangible, non-transitory, computer-readable information recording medium that is an optical disk, a magnetic disk, a semiconductor memory, or other media, and the program can be provided through the information storage medium. Instead of the aspect in which the program is stored in such a tangible non-transitory information recording medium and provided, the program signal can be provided as a download service by using the electric telecommunication line such as the Internet.

In addition, a part or some of the processing functions of the display control device 2 described in the above embodiment may be implemented by cloud computing, and it is also possible to perform a service of providing the processing functions as a software as a service (SaaS) service.

### Advantages of Present Embodiment

With the display control device 2 and the imaging system 10 according to the above embodiment of the present disclosure, the following advantages are obtained.
[1] The in-focus region is in the image IM can be clearly presented to the user.
[2] The user can check the image content for the region outside the range of the depth of field, so that the composition can be checked while checking the focusing state.
[3] The display brightness difference (density difference) between the region within the range of the depth of field and the region outside the range of the depth of field can be increased by determining the set gradation characteristic value applied to the region outside the range of the depth of field in accordance with the index value of the brightness of the region within the range of the depth of field in accordance with the default setting for the display brightness.
[4] In addition to the default setting, as described with reference to FIG. 15, the user can freely set the gradation characteristics of the display, so that each user can also set the brightness that is easy to see.
[5] The display of the live view image can be switched to the display of the image IM before the brightness change via the user interface such as the menu screen, and the display of the live view image after the brightness change can be restored. By enabling such display to be switched, the user can change the display to the image IM before the brightness change as necessary, and can perform imaging while adjusting, for example, the white balance of the actual image IM.

### Modification Example 1

In the above embodiment, the pixel depth that is the information on the subject distance is calculated for each pixel in the image IM, but the present disclosure is not limited to the configuration in which the information on the subject distance (information on the depth) is acquired in units of pixels, and for example, the information on the subject distance may be acquired in units of a pixel block that is a collection of a plurality of pixels.

### Modification Example 2

The present disclosure is not limited to the configuration in which the information on the subject distance is acquired based on the information on the phase difference pixel, and for example, the information on the subject distance may be acquired by using a distance-measuring sensor or other distance-measuring device.

### Modification Example 3

In the above embodiment, the processor 4 acquires the distance coefficient k for each pixel and determines the gradation characteristics based on the distance coefficient k, but the present disclosure is not limited to this configuration, and for example, the processor 4 may acquire the distance information for each subject, calculate the distance in the depth direction from the focus position of each subject based on the distance information for each subject and the subject distance of the focus position, and determine the gradation characteristics in accordance with the calculated distance. The value of the depth (pixel depth x) of each pixel in the image is an example of the distance information of the subject corresponding to the pixel. The processor 4 may determine the gradation characteristics in accordance with “x−L” or “L−x” that is the information on the distance in the depth direction from the focus position, instead of the distance coefficient k defined by Expression (4).

### Modification Example 4

The information on the subject distance for the region outside the range of the depth of field may be calculated from the blurriness of the image. For example, the processor 4 may evaluate an amount of blur indicating the blurriness of the image by performing edge detection on the image using a Laplacian filter, and convert the amount of blur into the information on the depth.

### Modification Example 5

The technology of the present disclosure is not limited to the camera 100 illustrated in FIGS. 10 and 11, and can be applied to various system forms, for example, a surveillance camera system, an in-vehicle camera system, a drone imaging system, a wearable camera system, a broadcast video imaging system, or a camera-equipped portable terminal such as a smartphone.

### [Others]

The present disclosure is not limited to the above embodiment, and various modifications can be made without departing from the gist of the technical idea of the present disclosure.

### EXPLANATION OF REFERENCES

2: display control device
4: processor
6: storage device
10: imaging system
12: image acquisition unit
16: display unit
18: operation unit
20: lens
22: stop
24: imaging optical system
26: imaging element
27A: light-shielding film
27B: light-shielding film
30: image brightness setting screen
32: brightness adjustment bar
34: image display area
36: mark
38: set button
50: imaging condition acquisition unit
52: image reception unit
54: main subject detection unit
56: depth-of-field calculation unit
58: brightness-in-depth-of-field evaluation unit
60: pixel depth calculation unit
62: normalized depth value calculation unit
64: set gradation characteristic value determination unit
66: gradation characteristic determination unit
68: display image generation unit
70: display image output unit
72: pixel value conversion unit
100: camera
102: interchangeable lens
103: stop
104: camera body
105: shutter release button
106: shutter speed dial
107: exposure correction dial
108: power lever
110: image sensor
112: EVF
114: MENU/OK key
116: cross key
117: play button
118: LCD
120: processor
130: memory
140: display driver
150: operation unit
170: sensor driver
180: AFE
AT: rectangular frame
CF: color filter
PD: photodiode
DSI, DSI2, DSI3: display image
F15A: left diagram
F15B: central diagram
F15C: right diagram
F20A: left diagram
F20B: right diagram
IM, IM2, IM3, IM5: image
LS: lens
ML: microlens
MLM: machine learning model
MS2, MS3, MS4: main subject
PD: photodiode
ZA: first phase difference pixel
ZB: second phase difference pixel
ST1 to ST6: step of display control method
ST11 to ST23: step of process of changing display brightness of live view image

What is claimed is:

1. A display control device comprising:
a processor is configured to:
acquire an image,
acquire information on a focus position of a depth of field of the image, and
determine gradation characteristics for displaying the image in accordance with the depth of field and a distance in a depth direction from the focus position in the image,
wherein the processor is configured to determine the gradation characteristics of a region outside a range of the depth of field such that an amount of change in a gradation with respect to a change in the distance increases as an F number increases.

2. The display control device according to claim 1,
wherein the processor is configured to determine the depth of field based on information on an F number of the image.

3. The display control device according to claim 1,
wherein the processor is configured to determine the gradation characteristics of the region outside the range of the depth of field, and displays the image.

4. The display control device according to claim 1,
wherein the processor is configured to:
acquire a region of a main subject in the image, and
make the gradation characteristics different between a first region that is the region of the main subject within a range of the depth of field in the image and a second region that is a region outside the range of the depth of field.

5. The display control device according to claim 1,
wherein the processor is configured to:
acquire distance information for each subject,
calculate the distance based on the distance information for each subject,
calculate the gradation characteristics based on the distance, and
determine the gradation characteristics in accordance with a subject distance of the focus position and the distance.

6. The display control device according to claim 5,
wherein the processor is configured to determine the gradation characteristics based on a value obtained by normalizing the distance by the depth of field of the image.

7. The display control device according to claim 1,
wherein the processor is configured to:
determine the gradation characteristics for reducing display brightness of the region outside the range of the depth of field in a case where an index value indicates the brightness that is equal to or greater than a first threshold value, and
determine the gradation characteristics for increasing the display brightness of the region outside the range of the depth of field in a case where the index value indicates the brightness that is less than the first threshold value.

8. The display control device according to claim 1,
wherein, in a case where an area ratio of a region within a range of the depth of field in the image is equal to or greater than a second threshold value, the processor is configured to change the gradation characteristics for displaying the region within the range of the depth of field, and fix the gradation characteristics for displaying a region outside the range of the depth of field.

9. The display control device according to claim 1,
wherein the gradation characteristics are expressed using a gamma function, and
the processor is configured to change the gradation characteristics by determining a coefficient of the gamma function.

10. The display control device according to claim 1,
wherein the image is an image captured by an imaging element including a phase difference pixel, and
the processor is configured to change the gradation characteristics in accordance with a value of a subject distance acquired from information on the phase difference pixel.

11. The display control device according to claim 10,
wherein the processor is configured to calculate the value of the subject distance corresponding to a pixel in the image by using a trained model that has been trained in advance on a relationship between the information on the phase difference pixel and the value of the subject distance.

12. The display control device according to claim 10,
wherein the processor is configured to change the gradation characteristics based on a plurality of combinations of the information on the phase difference pixel and the value of the subject distance.

13. A display control method executed by a processor, the display control method comprising:
acquiring an image;
acquiring information on a focus position of a depth of field of the image; and
determining gradation characteristics for displaying the image in accordance with the depth of field and a distance in a depth direction from the focus position in the image,
wherein, in determining the gradation characteristics, gradation characteristics of a region outside a range of the depth of field is determined such that an amount of change in a gradation with respect to a change in the distance increases as an F number increases.

14. A non-transitory, computer-readable tangible recording medium which records thereon, a program for causing a computer to implement:
a function of acquiring an image;
a function of acquiring information on a focus position of a depth of field of the image; and
a function of determining gradation characteristics for displaying the image in accordance with the depth of field and a distance in a depth direction from the focus position in the image,
wherein, in the function of determining the gradation characteristics, gradation characteristics of a region outside a range of the depth of field is determined such that an amount of change in a gradation with respect to a change in the distance increases as an F number increases.

15. An imaging device comprising:
an imaging optical system;
an imaging element that captures an image of a subject via the imaging optical system;
a display device that displays the image captured by the imaging element; and
the display control device according to claim 1.

16. The imaging device according to claim 15,
wherein the imaging element includes a phase difference pixel.

17. A display control device comprising:
a processor is configured to:
acquire an image,
acquire information on a focus position of a depth of field of the image, and
determine gradation characteristics for displaying the image in accordance with the depth of field and a distance in a depth direction from the focus position in the image,
wherein the processor is configured to determine gradation characteristics of a region outside a range of the depth of field, based on an index value related to brightness within a range of the depth of field.

18. The display control device according to claim 17,
wherein the processor is configured to determine display brightness of a region outside a range of the depth of field in accordance with a representative value of a region within the range of the depth of field.

19. The display control device according to claim 17,
wherein the processor is configured to:
acquire a region of a main subject in the image, and
determine the gradation characteristics in the region outside the range of the depth of field, based on the index value related to brightness of the region of the main subject within the range of the depth of field.

20. A display control method executed by a processor, the display control method comprising:
acquiring an image;
acquiring information on a focus position of a depth of field of the image; and
determining gradation characteristics for displaying the image in accordance with the depth of field and a distance in a depth direction from the focus position in the image,
wherein in determining the gradation characteristics, gradation characteristics of a region outside a range of the depth of field is determined based on an index value related to brightness within a range of the depth of field.

21. A non-transitory, computer-readable tangible recording medium which records thereon, a program for causing a computer to implement:
a function of acquiring an image;
a function of acquiring information on a focus position of a depth of field of the image; and
a function of determining gradation characteristics for displaying the image in accordance with the depth of field and a distance in a depth direction from the focus position in the image,
wherein in the function of determining the gradation characteristics, gradation characteristics of a region outside a range of the depth of field is determined based on an index value related to brightness within a range of the depth of field.

22. An imaging device comprising:
an imaging optical system;
an imaging element that captures an image of a subject via the imaging optical system;
a display device that displays the image captured by the imaging element; and
the display control device according to claim 17.
